(19) United States
(12) Patent Application Publication
(10) Pub. No.: US 2026/0012918 A1
(43) Pub. Date: Jan. 8, 2026

(54) TERMINAL DEVICE, AND NETWORK DEVICE

(71) Applicant: GUANGDONG OPPO MOBILE TELECOMMUNICATIONS CORP., LTD., Dongguan (CN)

(72) Inventors: Jinyu ZHANG, Dongguan (CN); Rongyi HU, Dongguan (CN)

(21) Appl. No.: 19/325,636

(22) Filed: Sep. 11, 2025

Related U.S. Application Data
(63) Continuation of application No. PCT/CN2023/087919, filed on Apr. 12, 2023.

(51) Int. Cl. H04W 64/00; H04B 17/318; H04L 5/00; H04W 8/22

(52) U.S. Cl. CPC H04W 64/00; H04B 17/328; H04L 5/0051; H04W 8/22

(57) ABSTRACT

A terminal device includes: a processor and a memory, where the memory is configured to store a computer program; and the processor is configured to call and run the computer program stored in the memory, to cause the terminal device to perform: determining total positioning measurement time according to a maximum value among one or more periods of first positioning measurement time, where the one or more periods of first positioning measurement time correspond to one or more FRs.

### CROSS-REFERENCE TO RELATED APPLICATION

This application is a Continuation application of International Application No. PCT/CN2023/087919 filed on Apr. 12, 2023, which is incorporated herein by reference in its entirety.

### TECHNICAL FIELD

Embodiments of the present disclosure relate to the field of mobile communication technology, and in particular, to a communication method, an apparatus, a device, a medium, a chip, a product, and a program.

### RELATED ART

Positioning technology is one of core technologies of a modern communication system and a navigation system. For example, a satellite navigation system, Bluetooth, and wireless fidelity (WiFi) are all provided with a positioning function. Similarly, a modern cellular communication system also supports the positioning function, and various positioning technologies have gradually been introduced to the cellular communication system since 3G and 4G (long term evolution (LTE)) systems. The positioning technology is also supported in a fifth New Radio (5G NR) system.

However, how to determine positioning measurement time has always been a concern in the art.

### SUMMARY

Embodiments of the present disclosure provide a communication method, an apparatus, a device, a medium, a chip, a product and a program.

In a first aspect, the embodiments of the present disclosure provides a communication method, and the method includes:

determining, by a terminal device, total positioning measurement time according to a maximum value among one or more periods of first positioning measurement time, where the one or more periods of first positioning measurement time correspond to one or more frequency ranges (FRs).

In a second aspect, the embodiments of the present disclosure provide a communication method, and the method includes:
receiving, by a terminal device, first information in a case where the terminal device supports an independent gap configuration positioning reference signal (PRS) capability or in a case where the terminal device supports the independent gap configuration PRS capability and a first capability; or
receiving, by the terminal device, second information in a case where the terminal device supports the independent gap configuration PRS capability and a second capability or in a case where the terminal device supports the independent gap configuration PRS capability, the first capability and the second capability; where
the first capability indicates that the terminal device allows or supports configuring a first gap pattern as a per FR type, or the first capability indicates that the terminal device allows or supports the first gap pattern as a per FR type configured in a corresponding FR; the first gap pattern indicates a first measurement gap length (MGL) and a first measurement gap repetition period (MGRP);
the second capability indicates that the terminal device allows or supports configuring one or more first FR gaps in multiple concurrent gaps as the first gap pattern;
the first information indicates to configure the first gap pattern as the per FR type, or the first information indicates the first gap pattern as a per FR type configured in a corresponding FR; and
the second information indicates to configure the one or more first FR gaps in the multiple concurrent gaps as the first gap pattern.

In a third aspect, the embodiments of the present disclosure provide a communication method, and the method includes:

configuring, by a network device, one or more first frequency range (FR) gaps to a terminal device for positioning reference signal (PRS) measurement; where the one or more first FR gaps are used for PRS measurement and for the terminal device to determine total positioning measurement time according to a maximum value among one or more periods of first positioning measurement time, where the one or more periods of first positioning measurement time correspond to one or more FRs.

In a fourth aspect, the embodiments of the present disclosure provide a communication method, and the method includes:
configuring, by a network device, first information to a terminal device in a case where the network device receives support for an independent gap configuration positioning reference signal (PRS) capability transmitted by the terminal device or in a case where the network device receives support for the independent gap configuration PRS capability and a first capability transmitted by the terminal device; or
configuring, by the network device, second information to the terminal device in a case where the network device receives support for the independent gap configuration PRS capability and a second capability transmitted by the terminal device or in a case where the network device receives support for the independent gap configuration PRS capability, the first capability and the second capability transmitted by the terminal device; where
the first capability indicates that the terminal device allows or supports configuring a first gap pattern as a per FR type, or the first capability indicates that the terminal device allows or supports the first gap pattern as a per FR type configured in a corresponding FR; the first gap pattern indicates a first measurement gap length (MGL) and a first measurement gap repetition period (MGRP);
the second capability indicates that the terminal device allows or supports configuring one or more first FR gaps in multiple concurrent gaps as the first gap pattern;
the first information indicates to configure the first gap pattern as the per FR type, or the first information indicates the first gap pattern as a per FR type configured in a corresponding FR; and
the second information indicates to configure the one or more first FR gaps in the multiple concurrent gaps as the first gap pattern.

In a fifth aspect, the embodiments of the present disclosure provide a communication apparatus, and the communication apparatus includes:

a determining unit, configured to determine total positioning measurement time according to a maximum value among one or more periods of first positioning measurement time, where the one or more periods of first positioning measurement time correspond to one or more frequency ranges (FRs).

In a sixth aspect, the embodiments of the present disclosure provides a communication apparatus, and the communication apparatus includes:
a communication unit, configured to: receive first information in a case where an independent gap configuration positioning reference signal (PRS) capability is supported or in a case where the independent gap configuration PRS capability and a first capability are supported; or receive second information in a case where the independent gap configuration PRS capability and a second capability are supported or in a case where the independent gap configuration PRS capability, the first capability and the second capability are supported; where
the first capability indicates that the terminal device allows or supports configuring a first gap pattern as a per FR type, or the first capability indicates that the terminal device allows or supports the first gap pattern corresponding to as a per FR type configured in a corresponding FR; the first gap pattern indicates a first measurement gap length (MGL) and a first measurement gap repetition period (MGRP);
the second capability indicates that the terminal device allows or supports configuring one or more first FR gaps in multiple concurrent gaps as the first gap pattern;
the first information indicates to configure the first gap pattern as the per FR type, or the first information indicates the first gap pattern as the per FR type configured in the corresponding FR; and
the second information indicates to configure the one or more first FR gaps in the multiple concurrent gaps as the first gap pattern.

In a seventh aspect, the embodiments of the present disclosure provide a communication apparatus, and the communication device apparatus:

a communication unit, configured to configure one or more first frequency range (FR) gaps to a terminal device for positioning reference signal (PRS) measurement; where the one or more first FR gaps are used for PRS measurement and for the terminal device to determine total positioning measurement time according to a maximum value among one or more periods of first positioning measurement time; where the one or more periods of first positioning measurement time correspond to one or more FRs.

In an eighth aspect, the embodiments of the present disclosure provide a communication apparatus, and the communication apparatus includes:
a communication unit, configured to: configure first information to a terminal device in response to receiving support for an independent gap configuration positioning reference signal (PRS) capability transmitted by the terminal device, or in response to receiving support for the independent gap configuration PRS capability and a first capability transmitted by the terminal device; or configure second information to the terminal device in response to receiving support for the independent gap configuration PRS capability and a second capability transmitted by the terminal device or in response to receiving support for the independent gap configuration PRS capability, the first capability and the second capability transmitted by the terminal device; where
the first capability indicates that the terminal device allows or supports configuring a first gap pattern as a per FR type, or the first capability indicates that the terminal device allows or supports the first gap pattern as a per FR type configured in a corresponding FR; the first gap pattern indicates a first measurement gap length (MGL) and a first measurement gap repetition period (MGRP);
the second capability indicates that the terminal device allows or supports configuring one or more first FR gaps in multiple concurrent gaps as the first gap pattern;
the first information indicates to configure the first gap pattern as the per FR type, or the first information indicates the first gap pattern as the per FR type configured in the corresponding FR; and
the second information indicates to configure the one or more first FR gaps in the multiple concurrent gaps as the first gap pattern.

In a ninth aspect, the embodiments of the present disclosure provide a terminal device, and the terminal device includes a processor and a memory, where
the memory is configured to store a computer program; and
the processor is configured to call and run the computer program stored in the memory, to cause the terminal device to perform the method according to the first aspect or the second aspect.

In a tenth aspect, the embodiments of the present disclosure provide a network device, and the network device includes a processor and a memory, where
the memory is configured to store a computer program, and
the processor is configured to call and run the computer program stored in the memory, to cause the network device to perform the method according to the third aspect or the fourth aspect.

In an eleventh aspect, the embodiments of the present disclosure provide a non-transitory computer storage medium, the non-transitory computer storage medium stores one or more programs, and the one or more programs are executable by one or more processors, to implement the method according to the first aspect, or the second aspect, or the third aspect, or the fourth aspect.

In a twelfth aspect, the embodiments of the present disclosure provide a chip, including a processor configured to call and run a computer program from a memory, to implement the method according to the first aspect, or the second aspect, or the third aspect, or the fourth aspect.

In a thirteenth aspect, the embodiments of the present disclosure provide a computer program product, the computer program product includes a non-transitory computer storage medium, and the non-transitory computer storage medium stores a computer program. The computer program includes instructions that are executable by at least one processor, and when the instructions are executed by the at least one processor, the method according to the first aspect, or the second aspect, or the third aspect, or the fourth aspect is implemented.

In a fourteenth aspect, the embodiments of the present disclosure provide a computer program, and the computer program causes a computer to execute the method according to the first aspect, or the second aspect, or the third aspect, or the fourth aspect.

### BRIEF DESCRIPTION OF THE DRAWINGS

Drawings described here are intended to provide further understanding of the present disclosure and constitute a part of the present disclosure. Exemplary embodiments of the present disclosure and their descriptions are intended to explain the present disclosure and do not constitute improper limitations on the present disclosure. In the drawings:

FIG. 1 is a schematic diagram illustrating an application scenario in embodiments of the present disclosure;

FIG. 2 is a flowchart of a communication method provided in embodiments of the present disclosure;

FIG. 3 is a flowchart of another communication method provided in embodiments of the present disclosure;

FIG. 4 is a flowchart of yet another communication method provided in embodiments of the present disclosure;

FIG. 5 is a flowchart of yet another communication method provided in embodiments of the present disclosure;

FIG. 6 is a schematic diagram of structural composition of a communication apparatus provided in embodiments of the present disclosure;

FIG. 7 is a schematic diagram of structural composition of another communication apparatus provided in embodiments of the present disclosure;

FIG. 8 is a schematic diagram of structural composition of yet another communication apparatus provided in embodiments of the present disclosure;

FIG. 9 is a schematic diagram of structural composition of yet another communication apparatus provided in embodiments of the present disclosure;

FIG. 10 is a schematic structural diagram of a communication device provided in embodiments of the present disclosure; and

FIG. 11 is a schematic structural diagram of a chip in embodiments of the present disclosure.

### DETAILED DESCRIPTION

Technical solutions in embodiments of the present disclosure will be described below in conjunction with drawings of the embodiments of the present disclosure. However, the described embodiments are some but not all of the embodiments of the present disclosure. All other embodiments obtained by those ordinary skilled in the art based on the embodiments of the present disclosure shall fall within the protection scope of the present disclosure.

The technical solutions described in the embodiments of the present disclosure may be combined arbitrarily if there is no conflict. In the description of the present disclosure, “a plurality of”, “the plurality of”, “multiple” or “the multiple” means two or more than two, unless otherwise clearly and specifically defined.

In the embodiments of the present disclosure, unless otherwise specified, identical symbols in different embodiments may be the same, may correspond to each other or may refer to each other, and corresponding symbols in different embodiments may correspond to each other or may refer to each other.

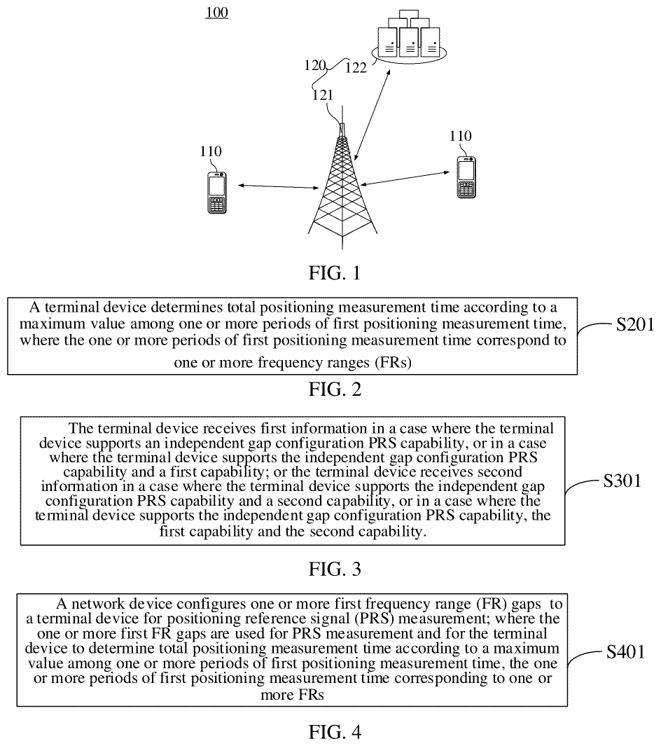

FIG. 1 is a schematic diagram of an application scenario in embodiments of the present disclosure. As shown in FIG. 1, a communication system 100 may include terminal devices 110 and a network device 120. The network device 120 may communicate with the terminal devices 110 via an air interface. Multi-service transmission is supported between the terminal device 110 and the network device 120.

It should be understood that the embodiments of the present disclosure are merely described by taking the communication system 100 as an example, but the embodiments of the present disclosure are not limited thereto. In other words, the technical solutions of the embodiments of the present disclosure can be applied to various communication systems, such as a global system of mobile communication (GSM), a code division multiple access (CDMA) system, a wideband code division multiple access (WCDMA) system, a general packet radio service (GPRS) system, a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a universal mobile telecommunication system (UMTS), a wireless local area network (WLAN), a wireless fidelity (WiFi) system, an LTE time division duplex (TDD) system, a universal mobile telecommunication system (UMTS), an Internet of things (IoT) system, a narrow band Internet of things (NB-IoT) system, an enhanced machine-type communications (eMTC) system, and a future communication system (e.g., 6G communication system or 7G communication system).

In the embodiments of the present disclosure, the network device 120 may include an access network device 121 and/or a core network device 122. The access network device may provide communication coverage for a certain geographical area, and may communicate with terminal devices 110 (e.g., UEs) located within the coverage area.

The terminal device in any one of the embodiments of the present disclosure may be a device with a wireless communication function, which may be deployed on land, including indoors or outdoors, in a handheld or vehicle-mounted form. Alternatively, the terminal device may be deployed on water (e.g., a steamship). Alternatively, the terminal device may be deployed in the air (e.g., on an airplane, a balloon, and a satellite). The terminal device in any one of the embodiments of the present disclosure may be referred to as a user equipment (UE), a mobile station (MS), a mobile terminal (MT), a user unit, a user station, a mobile console, a remote station, a remote terminal, a mobile device, a user terminal, a terminal, a wireless communication device, a user agent, or a user apparatus. The terminal device in any one of the embodiments of the present disclosure may include one of or a combination of at least two of the following: an Internet of things (IoT) device, a satellite terminal, a wireless local loop (WLL) station, a personal digital assistant (PDA), a handheld device with a wireless communication function, a computing device or other processing device connected to a wireless modem, a server, a mobile phone, a tablet computer (pad), a computer with a wireless transceiver function, a handheld computer, a desktop computer, a personal digital assistant, a portable media player, a smart speaker, a navigation device, a smart watch, a smart glasses, a smart necklace and other wearable devices, a pedometer, a digital TV, a virtual reality (VR) terminal device, an augmented reality (AR) terminal device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, a vehicle in an Internet of Vehicle (IoV) system, a vehicle-mounted device, a vehicle-mounted module, a wireless modem, a handheld device, a customer premise equipment (CPE), a smart home appliance, or the like.

Optionally, the terminal device may be any terminal device, including but not limited to a terminal device connected to a network device or other terminal devices in a wired or wireless manner.

Optionally, the terminal device may be used for device to device (D2D) communication.

In any one of the embodiments of the present disclosure, the access network device may include one of or a combination of at least two of the following: an evolutional Node B (eNB or eNodeB) in a long term evolution (LTE) system, a next generation radio access network (NG RAN) device, a base station (gNB) in an NR system, a small station, a micro station, a wireless controller in a cloud radio access network (CRAN), an access point of a wireless fidelity (Wi-Fi), a transmission reception point (TRP), a relay station, an access point, a vehicle-mounted device, a wearable device, a hub, a switch, a bridge, a router, a network device in a future evolved public land mobile network (PLMN), or the like.

In any one of the embodiments of the present disclosure, the core network device may be a 5th generation (5G) core network (5G Core, 5GC) device, and the core network device may include one of or a combination of at least two of the following: a sensing function (SF), an access and mobility management function (AMF), an authentication server function (AUSF), a user plane function (UPF), a session management function (SMF), a location management function (LMF), or a policy control function (PCF). In some other implementations, the core network device may also be an evolved packet core (EPC) device of an LTE network, for example, a session management function+core packet gateway (SMF+PGW-C) device of the core network. It should be understood that SMF+PGW-C may simultaneously implement functions implemented by SMF and PGW-C. During a network evolution process, the above-mentioned core network device may also be referred to as other names, or a new network entity may be formed by dividing functions of the core network, which will not be limited in the embodiments of the present disclosure.

Various function units in the communication system may also establish connections and communicate with each other via a next generation (NG) network interface.

For example, the terminal device establishes an air interface connection with the access network device via the NR interface, to transmit user plane data and control plane signaling. The terminal device may establish a control plane signaling connection with the AMF via an NG interface 1 (N1 for short). The access network device such as a next generation wireless access base station (gNB) may establish a user plane data connection with the UPF via an NG interface 3 (N3 for short). The access network device may establish a control plane signaling connection with the AMF via an NG interface 2 (N2 for short). The UPF may establish a control plane signaling connection with the SMF via an NG interface 4 (N4 for short). The UPF may exchange user plane data with a data network via an NG interface 6 (N6 for short). The AMF may establish a control plane signaling connection with the SMF via an NG interface 11 (N11 for short). The SMF may establish a control plane signaling connection with the PCF via an NG interface 7 (N7 for short).

FIG. 1 exemplarily illustrates one base station, one core network device and two terminal devices. Optionally, the wireless communication system 100 may include a plurality of base stations, and there may be other number of terminal devices within a coverage of each base station, which will not be limited in the embodiments of the present disclosure.

It will be noted that FIG. 1 is merely an example of a system to which the present disclosure is applicable. Certainly, the method in the embodiments of the present disclosure may also be applied to other systems. In addition, the terms “system” and “network” are often used interchangeably herein. The term “and/or” herein is only an association relationship to describe associated objects, which means that there may be three kinds of relationships. For example, A and/or B may represent three cases where: A exists alone, both A and B exist, and B exists alone. Moreover, a character “/” herein generally means that related objects before and after the character “/” are in an “or” relationship. It can be further understood that “indicate/indicating/indicated” in the embodiments of the present disclosure may be a direct indication, may be an indirect indication, or may represent an association relationship. For example, A indicating B may mean that A directly indicates B, for example, B may be obtained by A. Alternatively, A indicating B may mean that A indirectly indicates B, for example, A indicates C, and B may be obtained through C. Alternatively, A indicating B may mean that there is an association relationship between A and B. It can be further understood that in the embodiments of the present disclosure, the term “correspond/corresponding/correspondence” may mean that there is a direct or indirect correspondence between two elements. Alternatively, “correspond/corresponding/correspondence” may mean that there is an association relationship between two elements. Alternatively, “correspond/corresponding/correspondence” may mean that there is a relationship of indicating and being indicated, or a relationship of configuring and being configured, etc. It can be further understood that in the embodiments of the present disclosure, “pre-defined”, “agreed by a protocol”, “predetermined” or “a predefined rule” may be implemented by pre-storing corresponding codes, tables or other methods for indicating related information in devices (for example, the devices including a terminal device and a network device), and the specific implementations in the present disclosure are not limited thereto. For example, “pre-defined” may refer to those defined in a protocol. It can be further understood that “protocols” in the embodiments of the present disclosure may refer to standard protocols in the communication field, which may include, for example, an LTE protocol, an NR protocol and related protocols employed in the future communication system, which will not be limited in the present disclosure.

Some positioning manners and their corresponding measurement variables are listed below.

(1) Downlink-time difference of arrival (DL-TDOA) positioning manner, requires that the terminal device measures arrival time difference or reference signal time difference (RSTD) between positioning reference signals (PRSs) transmitted from multiple base stations.

(2) Uplink-time difference of arrival (UL-TDOA) positioning manner, requires that a base station measures time difference (relative time of arrival (RTOA)) between a sounding reference signal (SRS) transmitted by a user and a certain reference timing.

(3) Multi-round trip time (Multi-RTT) positioning manner, requires that the base station and the terminal device each measure an Rx-Tx time difference.

(4) Downlink-angle of departure (DL-AoD) positioning manner, requires that the terminal device measures reference signal received power (RSRP) for a PRS transmitted from the base station.

(5) Uplink-angle of arrival (UL-AoA) positioning manner, requires that the base station measures an uplink angle of arrival (AoA).

(6) Enhanced cell identification (ID) positioning manner, requires that the terminal device measures RSRP and/or a reference signal received quality (RSRQ) of a synchronization signal block (SSB) and/or a channel state information reference signal (CSI-RS) transmitted from the base station.

Optionally, in addition to the positioning manners and the corresponding measurement variables listed above, the present disclosure may further include other positioning manners and corresponding measurement variables, such as reference signal received path power (RSRPP), PRS phase measurement (with no abbreviation yet), etc. Optionally, the RSRPP may also be reference signal received power of each path for PRS.

In terms of formulating radio resource management (RRM) indicators, measurement behavior of a terminal device end, including measurement time required for each measurement variable and measurement accuracy required to be reached, is mainly considered. In release Rel-16, positioning measurement is performed within a measurement gap (MG), and the MG is of per UE type. A brief description is made below by taking an example in which measurement time for the reference signal time difference (RSTD) is measured within the MG. Based on an assumption that the UE can only process one positioning frequency layer at a time, a total measurement period (corresponding to total positioning measurement time or being the total positioning measurement time) is calculated by summing measurement time of all frequency layers to be measured. The measurement time T_{RSTD,i} of each frequency layer is related to the following factors: a number of samplings N_sample, an MG shared amplification factor (e.g., a carrier specific scaling factor (CSSF)) and a receive beam scanning factor N_{RxBeam,i}, downlink (DL) PRS processing capabilities N and N′, a silent mechanism, a DL PRS processing delay, a DL PRS period, an MG period, and an effective measurement time unit T_{effect,i}.

The total measurement period (T_{RSTD,Total}) may be calculated by the following Formula (1):

$${T}_{RSTD , Total} = {\sum }_{i = 1}^{L} {T}_{RSTD , i} + ( L - 1 ) * max ( {T}_{effect , i} ) ; \qquad ( 1 )$$

where i is an index of a positioning frequency layer;
L is a total number of positioning frequency layers; and
T_{effect,i} is a period for PRS RSTD measurement on a positioning frequency layer i.

In some embodiments, T_{RSTD,i} is calculated by the following Formula (2):

$${T}_{RSTD , i} = ( {k}_{multiTEG , i} * {CSSF}_{PRS , i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{{available}_{PRS} , i}}{N} ⌉ * {N}_{sample} - 1 ) * {T}_{effect , i} + {T}_{last , i} ; \qquad ( 2 )$$

where N_{RxBeam,i} is a receive (Rx) beam scanning factor of the terminal device;
CSSF_{PRS,i} is a carrier specific scaling factor for new radio PRS-based (NR PRS-based) positioning measurement in the positioning frequency layer i;
k_{multiTEG,i} is a scaling factor for measuring a same PRS resource having multiple Rx time error groups (TEGs);
K_{p,PRS,i} is a scaling factor for a positioning frequency layer to be measured within an associated measurement gap pattern;

$${N}_{P R S , i}^{slot}$$

is a maximum number of downlink (DL) PRS resources in the positioning frequency layer i configured in one slot;
N is duration of a DL PRS symbol, measured in milliseconds (ms);
L_{available_PRS,i} is duration of available PRS in the positioning frequency layer i to be measured during T_{available_PRS,i}; T_{available_PRS,i}=LCM(T_{PRS,i}, MGRP), where LCM(T_{PRS,i}, MGRP) is a least common multiple of T_{PRS,i} and a MG repetition period (MGRP), and T_{PRS,i} is a period of silent DL PRS resources on the positioning frequency layer i;
N′ is a capability for which the terminal device is capable of processing a number of DL PRS resources in one slot;
Nₛₐₘₚₗₑ is a number of samples for PRS RSTD measurement;
T_{effect,i} is a period of PRS RSTD measurement in the positioning frequency layer i; and
T_{last,i} is measurement duration for a last PRS RSTD sample in the positioning frequency layer i.

In some embodiments, T_{last,i} includes sampling time and processing time.

If the positioning frequency layer i is in case 1 and all PRS resources to be measured during T_{available} are within a same MG occasion, T_{last,i}=Tᵢ+MGL, where the MGL is a length of a measurement gap;

otherwise, T_{last,i}=Tᵢ+T_{available_PRS,i}.

Tᵢ corresponds to parameter Tms (in duration of PRS-processing symbols in every Tms, durationOfPRS-ProcessingSymbolsInEveryTms) in terminal capabilities. Optionally, the durationOfPRS-ProcessingSymbolsInEveryTms capability includes parameter T and parameter N, which indicate that the terminal device can process a PRS signal for Nms in every Tms, where N is the duration of the DL PRS symbol.

In some embodiments, a carrier specific scaling factor within gap (CSSF within gap) is calculated as described in the Formula (1) and Formula (2). The scaling factor is mainly used to indicate a delay of measurement time caused by sharing MG between PRS measurement and other RRM measurement(s). For example, for a standalone (SA) mode, the main features are as follows: 1) when calculating a CSSF of positioning measurement, only a current positioning frequency is assumed while other positioning frequencies are ignored; and when calculating a CSSF of RRM measurement, all positioning frequencies need to be polled in turn, and a largest CSSF is used as the CSSF for calculating the measurement time in the above Formula.

In some embodiments, in a case where multiple positioning frequency layers are configured, assuming no other positioning frequency layers are configured for each positioning frequency layer i, CSSFwithin_gap,i is derived through the following steps.

For each RRM frequency layer i, CSSFwithin_gap,i is derived as follows.

Assuming that only positioning frequency layer k is configured, an intermediate CSSFwithin_gap,i,k is derived by following steps, and

CSSFwithin_gap,i=max(CSSFwithin_gap,i,k), where k=0 . . . K−1, and K is a number of configured positioning frequency layers. For each measurement gap j not used for a long-periodicity measurement, a total number of all candidates measured within gap j is counted, where the candidates include intra-frequency (corresponding to same-frequency measurement) measurement objects and inter-frequency (corresponding to different-frequency measurement)/inter-RAT (inter-RAT corresponds to different-system measurement) measurement objects and PRS measurements.

For an NR measurement object configured with SSB measurement, if its SSB-based measurement timing configuration (SMTC) duration is fully covered by the measurement gap length (MGL) (excluding radio frequency (RF) switching time), the NR measurement object is a candidate to be measured in a gap. For intra-frequency NR measurement objects, if smtc2 is configured for a higher layer signaling, an assumed periodicity of SMTC occasions corresponds to a value of higher layer parameter smtc2; otherwise, the assumed periodicity of SMTC occasions corresponds to a value of higher layer parameter smtc1.

For an NR measurement object configured with CSI-RS measurement, if a window confining all CSI-RS resources is fully covered by a measurement gap length (MGL) (excluding the RF switching time), the NR measurement object configured with CSI-RS measurement is a candidate to be measured in a gap.

For an NR measurement object configured with a received signal strength indicator (RSSI) and channel occupancy measurement, if a RSSI and channel occupancy measurement timing configuration (RMTC) duration is fully covered by the MGL (excluding the RF switching time), the NR measurement object configured with the RSSI and channel occupancy measurement is a candidate measurement object in a gap.

If an inter-frequency system frame number and frame timing difference (SFTD) measurement object is to be measured with measurement gaps, the measurement object is a candidate to be measured in all measurement gaps.

If at least one PRS resource on a positioning frequency layer is fully covered by the MGL (excluding the RF switching time), the positioning frequency layer is counted as a candidate for a measurement gap.

For UEs which support and are configured with per FR gaps, the counting is done on a per FR basis, and for UEs configured with per UE gaps, the counting is done on a per UE basis. For UEs which support and are configured with per FR gaps, CSSF requirements do not apply when the NR PRS measurement in one FR gap collides with SSB/CSI-RS/PRS measurements in another FR gap in time domain.

M_{intra,i,j} is a number of intra-frequency measurement objects, including both SSB and CSI-RS based and RSSI/channel occupancy (CO) measurements, which are candidates to be measured in gap j, where measurement object i is also a candidate for gap j. Otherwise, M_{intra,i,j} is equal to 0.

M_{inter,i,j} is a number of NR inter-frequency layers including SSB measurements, CSI-RS-based measurements, evolved universal terrestrial radio access (EUTRA) inter-RAT (EUTRA inter-RAT) and universal terrestrial radio access technology (UTRA) inter-RAT (UTRA inter-RAT) frequency layers for candidate measurements in gap j, up to one positioning frequency layer, RSSI/CO measurements, which are candidates to be measured in gap i, where the measurement object i is also a candidate. Otherwise, M_{inter,i,j} is equal to 0.

If a measurement object is configured with both RMTC and SMTC, the measurement object i in M_{intra,i,j} and M_{inter,i,j} is counted twice, and RMTC and SMTC are candidates to be measured in gap j, where the measurement object i is also a candidate.

M_{tot,i,j}=M_{intra,i,j}+M_{inter,i,j} is a total number of intra-frequency, inter-frequency and inter-RAT frequency layers and up to one NR PRS measurement on any one positioning frequency layer, which are candidates to be measured in gap j, where the measurement object i is also a candidate. Otherwise, M_{tot,i,j} is equal to 0.

For each measurement gap j used for a long-periodicity measurement defined above, M_{intra,i,j}=M_{inter,i,j}=M_{tot,i,j}=0. The carrier specific scaling factor CSSF_{within_gap.i} is given by the following content.

If a measurement gap sharing scheme (measGapSharingScheme) is equal sharing, then CSSF_{within_gap,i}=max(ceil(Rᵢ×M_{tot,i,j})), where j=0 . . . (160/MGRP)−1, MGRP denoting a measurement gap repetition period.

If measGapSharingScheme is not equal sharing, and
measurement object i is an intra-frequency measurement object, CSSF_{within_gap,i} is the maximum among the following:

$$ceil ( {R}_{i} \times {K}_{intra} \times {M}_{intra , i , j} ) in gap j where {M}_{inter , i , j} \neq 0 , \\ where j = 0 … ( 160 / MGRP ) - 1 ; \\ and \\ ceil ( Ri \times {M}_{intra , i , j} ) in gap j where {M}_{inter , i , j} = 0 , \\ where j = 0 … ( 160 / MGRP ) - 1 ;$$

the measurement object i is an inter-frequency measurement object, an inter-RAT measurement object or an NR PRS measurement on any positioning frequency layer, and CSSF_{within_gap,i} is the maximum value of the following;

$$ceil ( {R}_{i} \times {K}_{inter} \times {M}_{inter , i , j} ) in gap j where {M}_{intra , i , j} \neq 0 ,$$

$$where j = 0 … ( 160 / MGRP ) - 1 ;$$

$$and$$

$$ceil ( {R}_{i} \times {M}_{inter , i , j} ) in gap j where {M}_{intra , i , j} = 0 ,$$

$$where j = 0 … ( 160 / MGRP ) - 1 ;$$

where Rᵢ is a maximum ratio of a first number to a second number, the first number is a number of measurement gaps where measurement object i is a candidate to be measured, and the second number is a number of measurement gaps where measurement object i is a candidate and is not used for the long-periodicity measurement defined above.

In the related art, the positioning measurement is enhanced according to the following 1) and/or 2).

1) A capability for measuring PRS per FR gap is introduced, and the capability is denoted by independent gap configuration Rel-17 (independentGapConfigPRS-r17). When the UE supports this capability, the PRS may be measured using per FR gap. If the UE does not support this capability, the PRS only can be measured using per UE gap.

2) A measurement outside the measurement gap (MG) is introduced, the user may measure the PRS within a PRS processing window (PPW) configured by a network instead of within the MG. The measurement time is shown in Formula (3) or Formula (4) where there is no scaling factor (CSSF) since the current protocol does not support time domain overlapping between the PRS measurement outside the gap (PRS outside the gap) and other measurement (SSB/CSI-RS).

If any one of the positioning frequency layers is in case 1, then

$${T}_{RSTD , Total} = {\sum }_{i = 1}^{L} {T}_{RSTD \_ wo \_ gap , i} + ( L - 1 ) * max ( {T}_{effect , i} ) \qquad ( 3 )$$

Alternatively, if all positioning frequency layers are in case 2, then

$${T}_{RSTD , Total} = max ( {T}_{RSTD \_ wo \_ gap , i} + {T}_{uncertainty , i} ) ; \qquad ( 4 )$$

$$where {T}_{RSTD \_ wo \_ gap , i} = ( {k}_{multiTEG , i} * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i} ;$$

and

T_{uncertainty,i} is time from a start of the first PPW in the positioning frequency layer i to a start of the measurement period T_{PRS-RSRP,total}.

In some embodiments, a scenario is supported in which part of positioning frequency layers (PFLs) is measured within a PRS processing window (PPW) and another part of PFLs is measured within a measurement gap (MG), and the total measurement time is a sum of the two parts.

Therefore, in a case where a UE is configured with both MG applicable to positioning measurement and PPW,
the UE will measure the positioning frequency layer i based on (or within) MG, if PRS resources on the positioning frequency layer i are overlapped with MG; or
the UE will measure the positioning frequency layer i based on (or within) PPW, if PRS resources on the positioning frequency layer i are overlapped with PPW;
where the total positioning measurement time T_{RSTD,Total} is defined as:

$${T}_{RSTD , Total} = {T}_{RSTD , Total , MG} + {T}_{RSTD , Total , PPW} + {T}_{guard} ;$$

T_{RSTD,Total,MG} is defined in Formula (1) and includes all positioning frequency layers to be measured within the MG;
T_{RSTD,Total,PPW} is defined in Formula (3) or Formula (4) and includes all positioning frequency layers to be measured within the PPW; and
T_{guard} is a maximum T_{effect} among all positioning frequency layers (PFLs) defined above.

These requirements apply as long as the following conditions are satisfied:
MGs and PPWs do not overlap in time; and
each PFL (all PRS resources) configured in assistance data can be measured completely either within MG or activated PPW. Optionally, the assistance data may include signaling for configuring PRS.

In some embodiments, two new MG patterns #24 and #25 are introduced for positioning reference signal (PRS) measurement, and the two new MG patterns are allowed to be configured only when the UE needs to perform the PRS measurement.

MG #24 may be used for PRS and NR/LTE RRM measurements; MG #25 may be used for PRS and NR RRM measurements, but not for LTE measurement; MG #24 and MG #25 cannot be used for PRS sharing and 2G/3G RRM sharing.

Each of the two gaps is defined as per-UE, and whether corresponding gap pattern is supported depends on UE capability.

Table 1 is a description of MG pattern #24 and MG pattern #25.

TABLE 1

| | | Measuring gap |
|---|---|---|
| | Measurement gap | repetition period |
| Gap pattern Id | length (MGL, ms) | (MGRP, ms) |
| 24 | 10 | 80 |
| 25 | 20 | 160 |

Optionally, in any one of embodiments of the present disclosure, the gap pattern may also be replaced with a gap mode, a gap model, or a gap structure.

However, when the user supports per FR PRS (per frequency range gap) capability, whether the MG #24/25 is allowed to be configured as per FR type needs to be specified in the standards.

In some embodiments, in a case where the UE is configured, via LTE positioning protocol (LPP), to measure PRS for any RSTD, PRS-RSRP, and UE Rx-Tx time difference measurement defined in a measurement (there may be other positioning measurements such as measurements on RSRPP and phase), the network device provides:
a single per-UE measurement gap pattern for concurrent monitoring of all positioning frequency layers and intra-frequency, inter-frequency and/or inter-RAT frequency layers of all frequency ranges, or
for measurement gap patterns other than #24 and #25, if the UE supports independent measurement gap patterns for different frequency ranges for PRS measurement, per-FR measurement gap pattern for the frequency range for concurrent monitoring of all positioning frequency layers and intra-frequency, inter-frequency cells and/or inter-RAT frequency layers in the corresponding frequency range.

Therefore, it can be seen that even if the user supports the independent measurement gap capability, the MG #24/25 cannot be configured as per FR gap.

Based on SSB or CSI-RS measurements, the carrier specific scaling factor (CSSF) is statistically calculated according to per FR range if the UE supports and is configured as per FR gap. Such a rule can also apply to the PRS measurement, which means that positioning frequency points/frequency layers of different frequency ranges (FRs) may be received separately without interfering with each other. However, currently, the total PRS measurement time is still calculated in a summation manner, which is not accurate.

The positioning frequency points/frequency layers of FRs may be received separately without interfering with each other. From the perspective of RF, PFLs (positioning frequency layers) within different FR ranges may be parallel; in other words, the terminal device has an independent PRS gap capability. Optionally, in some embodiments, the independent PRS gap capability means that the PRS may be independently received and processed. Optionally, in some other embodiments, the independent PRS gap capability merely indicates that RF reception is independent, but a baseband processing unit may still be limited. In this case, a new capability needs to be introduced to indicate that the baseband processing unit is also independent.

To facilitate understanding of technical solutions in the embodiments of the present disclosure, the technical solutions of the present disclosure are described in detail below through exemplary embodiments. The solutions in the one or more embodiments above, as optional solutions, can be arbitrarily combined with the technical solutions in the embodiments of the present disclosure, and these combined solutions all belong to the protection scope of the embodiments of the present disclosure. The embodiments of the present disclosure include at least part of the following contents.

FIG. 2 is a flowchart of a communication method provided in embodiments of the present disclosure. As shown in FIG. 2, the method includes the following step.

In S201, a terminal device determines total positioning measurement time according to a maximum value among one or more periods of first positioning measurement time, where the one or more periods of first positioning measurement time correspond to one or more frequency ranges (FRs).

Optionally, the one or more periods of first positioning measurement time are in one-to-one correspondence with the one or more frequency ranges (FRs).

For example, the one or more FRs include a first FR and a second FR, and the terminal device determines the total positioning measurement time according to the maximum value between first positioning measurement time corresponding to the first FR and first positioning measurement time corresponding to the second FR.

For another example, the one or more FRs include a first FR, a second FR and a third FR, and the terminal device determines the total positioning measurement time according to the maximum value among first positioning measurement time corresponding to the first FR, first positioning measurement time corresponding to the second FR, and first positioning measurement time corresponding to the third FR. Optionally, first positioning measurement times corresponding to different FRs may be the same or different.

In the embodiments of the present disclosure, the terminal device determines the total positioning measurement time according to the maximum value among the one or more periods of first positioning measurement time, where the one or more periods of first positioning measurement time correspond to the one or more frequency ranges (FRs). The terminal device is capable of determining the total positioning measurement time according to the maximum value among the one or more periods of first positioning measurement time, which, compared with a solution in the related art in which the total positioning measurement time is determined according to a sum of one or more periods of first positioning measurement time, may reduce the total positioning measurement time, thereby improving the efficiency of positioning measurement.

Optionally, in any one of the embodiments of the present disclosure, measurement time may also be referred to as measurement duration. For example, positioning measurement time may be referred to as positioning measurement duration. For example, first positioning measurement time, second positioning measurement time, third positioning measurement time, and total positioning measurement time may be referred to as first positioning measurement duration, second positioning measurement duration, third positioning measurement duration, and total positioning measurement duration, respectively.

In some embodiments, the terminal device determining the total positioning measurement time according to the maximum value among the one or more periods of first positioning measurement time includes:

the terminal device determining the total positioning measurement time according to first time and the maximum value among the one or more periods of first positioning measurement time.

Optionally, in any one of the embodiments of the present disclosure, the first time may include guard time T_{guard}, or may include margin time T_{margin}, or may include redundant time.

Optionally, in any one of the embodiments of the present disclosure, the guard time guard may have the same meaning as the margin time T_{margin}. That is, the guard time T_{guard} and the margin time T_{margin} may be interchangeable.

It will be noted that in any one of the embodiments of the present disclosure, T_{guard} and/or T_{margin} may have other Chinese interpretations besides the guard time and/or the margin time in other embodiments, which will not be limited in the embodiments of the present disclosure.

Optionally, in any one of the embodiments of the present disclosure, the first time may be referred to as first duration.

Optionally, the first time may include a maximum T_{effect} among all positioning frequency layers. Optionally, the first time may include a maximum T_{effect} among all positioning frequency layers in one or more FRs. Optionally, the first time may include a maximum period of Y measurement on all positioning frequency layers.

Optionally, in any one of the embodiments of the present disclosure, T_{effect} is a period of Y measurement for each positioning frequency layer.

In some embodiments, first positioning measurement time corresponding to each FR is determined according to measurement time of each FR and second time corresponding to each FR.

Optionally, in any one of the embodiments of the present disclosure, the second time corresponding to each FR may include guard time corresponding to each FR. Alternatively, the second time corresponding to each FR may include margin time T_{margin} corresponding to each FR. Alternatively, the second time corresponding to each FR may include redundant time corresponding to each FR.

Optionally, in any one of the embodiment of the present disclosure, the second time may be referred to as second duration.

Optionally, the second time corresponding to each FR may include a maximum T_{effect} among all positioning frequency layers in each FR. For example, second time corresponding to the first FR may include a maximum T_{effect} among all positioning frequency layers in the first FR, second time corresponding to the second FR may include a maximum T_{effect} among all positioning frequency layers in the second FR, and second time corresponding to the third FR may include a maximum T_{effect} among all positioning frequency layers in the third FR, and so on.

Optionally, the second time corresponding to each FR may include a maximum period of Y measurement on all positioning frequency layers in each FR.

Optionally, in any one of the embodiments of the present disclosure, Y includes at least one of: PRS RSTD, RSRP for PRS, reference signal received path power (RSRPP) for PRS, or Rx-Tx time difference.

For example, T_{effect} is a period of PRS RSTD measurement for each positioning frequency layer. For another example, the first time may be the maximum T_{effect} among all positioning frequency layers in one or more FRs, where T_{effect} is a period of PRS RSTD measurement for each positioning frequency layer.

Optionally, in any one of the embodiments of the present disclosure, T_{effect} corresponding to a single positioning frequency layer i may be determined based on the following method:

$${T}_{effect , i} = ⌈ \frac{{T}_{i}}{{T}_{available \_ PRS , i}} ⌉ * {T}_{available \_ PRS , i} ;$$

where Tᵢ corresponds to durationOfPRS-ProcessingSymbolsInEveryTms; and
T_{available_PRS,i}=LCM(T_{PRS,i}, T_{DRX}), LCM(T_{PRS,i}, T_{DRX}) is a least common multiple of T_{PRS,i} and a DRX cycle length T_{DRX}, and T_{PRS,i} is a period of silent DL PRS resources on the positioning frequency layer i.

In some embodiments, the terminal device determining the total positioning measurement time according to the first time and the maximum value among the one or more periods of first positioning measurement time includes:

the terminal device determining the total positioning measurement time according to the sum of the first time and the maximum value among the one or more periods of first positioning measurement time.

Optionally, the terminal device may determine the sum of the first time and the maximum value among the one or more periods of first positioning measurement time as the total positioning measurement time.

Optionally, the terminal device may add one or more other values to the sum of the first time and the maximum value among the one or more periods of first positioning measurement time and/or subtract one or more other values from the sum of the first time and the maximum value among the one or more periods of first positioning measurement time, to obtain the total positioning measurement time.

In some embodiments, the first positioning measurement time corresponding to each FR is determined according to a sum of measurement time of each FR and the second time corresponding to each FR.

Optionally, each period of first positioning measurement time may be determined by the sum of the measurement time of each FR and the second time corresponding to each FR.

Optionally, each period of first positioning measurement time may be obtained by adding one or more other values to the sum of the measurement time of each FR and the second time corresponding to each FR and/or subtracting one or more other values from the sum of the measurement time of each FR and the second time corresponding to each FR.

In some embodiments, the terminal device determining the total positioning measurement time according to the maximum value among the one or more periods of first positioning measurement time includes:

in a case where the terminal device supports an independent gap configuration PRS (independentGapConfigPRS, where independentGapConfigPRS is also referred to as independentGapConfigPRS-r17) capability and the terminal device is configured with one or more first FR gaps for PRS measurement, the terminal device determining the total positioning measurement time according to the maximum value among the one or more periods of first positioning measurement time.

Optionally, in any one of the embodiments of the present disclosure, the first FR gap includes a per FR gap.

Optionally, in a case where the terminal device reports support for the independentGapConfigPRS capability to the network device, the network device configures one or more per FR gaps for PRS measurement to the terminal device, so that the terminal device determines the total positioning measurement time according to the maximum value of the one or more periods of first positioning measurement time.

In some embodiments, the terminal device determining the total positioning measurement time according to the maximum value among the one or more periods of first positioning measurement time includes:

in a case where the terminal device supports a simultaneous processing of PRS for different FRs (simulProcessingPrsDiffFR or simulaneousPRSdiffFR) capability and the terminal device is configured with one or more first FR gaps for PRS measurement, the terminal device determining the total positioning measurement time according to the maximum value among the one or more periods of first positioning measurement time.

Optionally, in a case where the terminal device reports support for the simultaneous processing of PRS for different FRs capability to the network device, the network device configures one or more per FR gaps for PRS measurement to the terminal device, so that the terminal device determines the total positioning measurement time according to the maximum value among the one or more periods of first positioning measurement time.

In some embodiments, the terminal device determining the total positioning measurement time according to the maximum value among the one or more periods of first positioning measurement time includes:

in a case where the terminal device supports the independent gap configuration PRS capability and supports the simultaneous processing of PRS for different FRs capability and the terminal device is configured with one or more first FR gaps for PRS measurement, the terminal device determining the total positioning measurement time according to the maximum value among the one or more periods of first positioning measurement time.

Optionally, in a case where the terminal device reports the independentGapConfigPRS capability and the support for the simultaneous processing of PRS for different FRs capability to the network device, the network device configures one or more per FR gaps for PRS measurement to the terminal device, so that the terminal device determines the total positioning measurement time according to the maximum value among the one or more periods of first positioning measurement time.

Optionally, the support for the independent gap configuration PRS capability and the support for the simultaneous processing of PRS for different FRs capability may be reported in the same signaling or in different signaling.

In some embodiments, the method further includes:

in a case where the terminal device does not support the simultaneous processing of PRS for different FRs capability, and/or the terminal device does not support the independent gap configuration PRS capability, and/or the terminal device is not configured with the one or more first FR gaps for PRS measurement, the terminal device determining the total positioning measurement time according to a sum of the one or more periods of first positioning measurement time.

Optionally, in a case where a capability reported by the terminal device to the network device does not include the support for the simultaneous processing of PRS for different FRs capability, the network device will not configure the one or more per FR gaps for PRS measurement to the terminal device, so that the terminal device fails to receive a configuration of the one or more per FR gaps for PRS measurement transmitted by the network device. In this case, the terminal device determines the total positioning measurement time according to the sum of the one or more periods of first positioning measurement time.

Optionally, in a case where the capability reported by the terminal device to the network device does not include the support for the independentGapConfigPRS capability, the network device will not configure the one or more per FR gaps for PRS measurement to the terminal device, so that the terminal device fails to receive the configuration of the one or more per FR gaps for PRS measurement transmitted by the network device. In this case, the terminal device determines the total positioning measurement time according to the sum of the one or more periods of first positioning measurement time.

Optionally, in a case where the capability reported by the terminal device to the network device does not include the support for the independentGapConfigPRS capability and does not include the support for the simultaneous processing of PRS for different FRs capability, the network device will not configure the one or more per FR gaps for PRS measurement to the terminal device, so that the terminal device fails to receive the configuration of the one or more per FR gaps for PRS measurement transmitted by the network device. In this case, the terminal device determines the total positioning measurement time according to the sum of the one or more periods of first positioning measurement time.

In some embodiments, the terminal device supporting the independent gap configuration PRS capability is independent of the terminal device supporting the simultaneous processing of PRS for different FRs capability.

Optionally, the terminal device supporting the independent gaps configuration PRS capability does not affect the terminal device supporting the simultaneous processing of PRS for different FRs capability. For example, the terminal device may support or may not support the independent gaps configuration PRS capability, and/or the terminal device may support or may not support the simultaneous processing of PRS for different FRs capability.

In some embodiments, the terminal device supporting the independent gaps configuration PRS capability is a basis for the terminal device supporting the simultaneous processing of PRS for different FRs capability.

Optionally, only when the terminal device supports the independent gap configuration PRS capability, the terminal device may support the simultaneous processing of PRS for different FRs capability. For example, in the case where the terminal device supports the independent gap configuration PRS capability, the terminal device supports or does not support the simultaneous processing of PRS for different FRs capability. Optionally, when the terminal device does not support the independent gap configuration PRS capability, the terminal device also does not support the simultaneous processing of PRS for different FRs capability.

In some embodiments, each period of first positioning measurement time is determined according to a sum of at least one second positioning measurement time, where the at least one second positioning measurement time is positioning measurement time of at least one positioning frequency layer in a FR corresponding to each period of first positioning measurement time.

For example, the one or more FRs include a first FR and a second FR. The terminal device may determine second positioning measurement time of at least one positioning frequency layer in the first FR (one positioning frequency layer corresponds to one second positioning measurement time), and determine a sum of the second positioning measurement time of at least one positioning frequency layer in the first FR as first positioning measurement time corresponding to the first FR. The terminal device may determine second positioning measurement time of at least one positioning frequency layer in the second FR, and determine a sum of the second positioning measurement time of at least one positioning frequency layer in the second FR as first positioning measurement time corresponding to the second FR.

In some embodiments, the method further includes: the terminal device receiving indication information, where the indication information indicates that a first gap pattern corresponds to per FR or per FR gap, or the indication information indicates that the first gap pattern corresponds to one or more per FRs/one or more per FR gaps. Optionally, the terminal device receiving the indication information may include the terminal device receiving the indication information transmitted by the network device.

In some embodiments, the method further includes: the terminal device receiving first information or second information, where the first information indicates to configure the first gap pattern as a per FR type, or the first information indicates the first gap pattern as the per FR type configured in the corresponding FR; and the second information indicates to configure one or more per FR gaps in multiple concurrent gaps as the first gap pattern.

Optionally, the indication information may include the first information or the second information.

Optionally, the terminal device receiving the first information or the second information includes: the terminal device receiving the first information or the second information transmitted by the network device.

In some embodiments, the method further includes: the terminal device receiving the first information in a case where the terminal device supports the independent gap configuration PRS capability or in a case where the terminal device supports the independent gap configuration PRS capability and a first capability.

In some embodiments, the method further includes: the terminal device receiving the second information in a case where the terminal device supports the independent gap configuration PRS capability and a second capability or in a case where the terminal device supports the independent gap configuration PRS capability, the first capability and the second capability.

Optionally, the first capability indicates that the terminal device allows or supports configuring the first gap pattern as the per FR type, or the first capability indicates that the terminal device allows or supports the first gap pattern as the per FR type configured in the corresponding FR; and the first gap pattern indicates a first measurement gap length (MGL) and a first measurement gap repetition period (MGRP).

Optionally, the second capability indicates that the terminal device allows or supports configuring one or more first FR gaps in the multiple concurrent gaps as the first gap pattern.

Optionally, the first information indicates to configure the first gap pattern as the per FR type, or indicates the first gap pattern as the per FR type configured in the corresponding FR.

Optionally, the second information indicates to configure one or more first FR gaps in the multiple concurrent gaps as the first gap pattern.

Optionally, the network device may transmit the first information to the terminal device in a case where the terminal device reports to the network device the support for the independent gap configuration PRS capability or in a case where the terminal device reports to the network device support for the independent gap configuration PRS capability and the first capability. Thus, the terminal device receives the first information.

Optionally, the network device may transmit the second information to the terminal device in a case where the terminal device reports to the network device the support for the independent gap configuration PRS capability and the second capability or in a case where the terminal device reports to the network device the support for the independent gap configuration PRS capability, the first capability and the second capability. Thus, the terminal device receives the second information.

Optionally, the one or more per FR gaps may be included in one gap combination, or the one or more per FR gaps may be included in multiple gap combinations.

In some embodiments, the first gap pattern includes MG pattern 24 and/or MG pattern 25.

Optionally, in a case where the first gap pattern includes the MG pattern 24, a first MGL indicated by the MG pattern 24 includes 10, and a first MGRP indicated by the MG pattern 24 includes 80.

Optionally, in a case where the first gap pattern includes the MG pattern 25, a first MGL indicated by the MG pattern 25 includes 20, and a first MGRP indicated by the MG pattern 24 includes 160.

Optionally, in a case where the first gap pattern includes the MG pattern 24 and the MG pattern 25, the first MGL indicated by the MG pattern 24 includes 10 and 20, and the first MGRP indicated by the MG pattern 24 includes 80 and 160.

In the related art, the network device may only configure one per UE gap for the terminal device; or the terminal device configures at most one per FR gap for per FR when the terminal device supports a per FR gap capability.

However, by introducing a multiple concurrent gap feature, the network device may be allowed to configure multiple gaps for the terminal device. For example, multiple gaps are multiple per UE gaps, or two FR1 gaps (e.g., FR1 gap1 and FR1 gap2) and one FR2 gap, or two FR2 gaps (e.g., FR2 gap1 and FR2 gap2) and one1 FR1 gap. Currently, a per FR gap of these combinations cannot be configured as gap pattern 24 and/or gap pattern 25 (also referred to as MG pattern 24 and/or MG pattern 25), and a per UE gap may be configured as gap pattern 24 and/or gap pattern 25.

Optionally, in a case where the terminal device supports the second capability, the terminal device may allow to configure one or more per FR gaps in a concurrent gap combination as MG pattern 24 and/or MG pattern 25. For example, it is assumed that, for the case of two FR1 gaps (e.g., FR1 gap1 and FR1 gap2) and one FR2 gap, only one of the FR1 gaps (e.g., FR1 gap1 or FR1 gap2) may be configured as 24, and others may use any one of gap patterns 0 to 23.

In some embodiments, a reporting manner of the first capability and/or the second capability is the same as a reporting manner of the independent gap configuration PRS capability.

Optionally, the reporting manner may include at least one of: active reporting, triggered reporting, reporting in response to receiving indication information transmitted by the network device, or reporting through a target procedure, etc.

Optionally, the first capability and/or the second capability may be reported via the same signaling together with the independent gap configuration PRS capability. For example, the first capability and/or the second capability, and the independent gap configuration PRS capability are all reported via first signaling.

Optionally, the first capability and/or the second capability, and the independent gap configuration PRS capability may be reported via different pieces of signaling. For example, the first capability and/or the second capability are reported via the first signaling, and the independent gap configuration PRS capability is reported via third signaling.

In some embodiments, the first capability and the second capability are reported via the first signaling. In this way, the first capability and the second capability are reported via the same signaling.

In some embodiments, the first capability is reported via the first signaling, and the second capability is reported via the second signaling. In this way, the first capability and the second capability are reported via different pieces of signaling. Optionally, the second capability may be reported before the first capability, or the second capability may be reported after the first capability. In some embodiments, the one or more FRs include a first FR and a second FR; and
the total positioning measurement time T_{Y,Total} is determined according to max(T_{Y,FR1}, T_{Y,FR2});
where T_{Y,FR1} is measurement time of measuring Y in the first FR, or measurement time of measuring Y in a first FR MG, or measurement time of measuring Y in a first FR PPW;
T_{Y,FR2} is measurement time of measuring Y in the second FR, or measurement time of measuring Y in a second FR MG, or measurement time of measuring Y in a second FR PPW; and
Y includes at least one of: PRS RSTD, RSRP for PRS, reference signal received path power (RSRPP) for PRS, or Rx-Tx time difference.

Optionally, the total positioning measurement time T_{Y,Total}=max(T_{Y,FR1}, T_{Y,FR2}).

For example, Y includes PRS RSTD, and the total positioning measurement time T_{RSTD,Total} is determined according to max(T_{RSTD,FR1}, T_{RSTD,FR2}). For example, T_{RSTD,Total}=max(T_{RSTD,FR1}, T_{RSTD,FR2}).

where T_{RSTD,FR1} is measurement time of PRS RSTD measurement in the first FR; and T_{RSTD,FR2} is measurement time of PRS RSTD measurement in the second FR.

It will be noted that although Y being the PRS RSTD is taken as an example in the present disclosure, in other embodiments, Y may be the RSRP for PRS, the reference signal received path power (RSRPP) for PRS, or the Rx-Tx time difference. In the case where Y is the RSRP for PRS, the reference signal received path power (RSRPP) for PRS or the Rx-Tx time difference, a method for determining the total positioning measurement time may be similar to the method for determining the total positioning measurement time in the case where Y is the PRS RSTD, which will not be listed one by one in the embodiments of the present disclosure.

In some embodiments, the one or more FRs include a first FR and a second FR; and

the total positioning measurement time T_{Y,Total} is determined according to max(T_{Y,FR1}, T_{Y,FR2})+T_{guard};
where T_{Y,FR1} is measurement time of measuring Y in the first FR, or measurement time of measuring Y in a first FR MG, or measurement time of measuring Y in a first FR PPW;
T_{Y,FR2} is measurement time of measuring Y in the second FR, or measurement time of measuring Y in a second FR MG, or measurement time of measuring Y in a second FR PPW;
T_{guard} is the first time, T_{guard} is a maximum T_{effect} among all positioning frequency layers, and T_{effect} is a period of Y measurement for each positioning frequency layer; T_{guard} is the first time; and
Y includes at least one of: PRS RSTD, RSRP for PRS, reference signal received path power (RSRPP) for PRS, or Rx-Tx time difference.

Optionally, T_{guard} is the maximum T_{effect} among all positioning frequency layers in the first FR and/or the second FR.

Optionally, T_{guard} is the maximum T_{effect} among all positioning frequency layers in the first FR MG and/or the second FR MG.

Optionally, T_{guard} is the maximum T_{effect} among all positioning frequency layers in the first FR PPW and/or the second FR PPW.

Optionally, T_{guard} is the maximum T_{effect} among all positioning frequency layers in the first FR MG and the first FR PPW, and/or in the second FR MG and the second FR PPW.

Optionally, the total positioning measurement time T_{Y,Total}=max(T_{Y,FR1}, T_{Y,FR2})+T_{guard}.

For example, Y includes the PRS RSTD, and the total positioning measurement time T_{RSTD,Total} is determined according to max(T_{RSTD,FR1}, T_{RSTD,FR2})+T_{guard}. For example, T_{RSTD,Total}=max(T_{RSTD,FR1}, T_{RSTD,FR2})+T_{guard}.

Optionally, in any one of the embodiments of the present disclosure, FR MG may be replaced with any one of: MG FR, FR corresponding to MG, FR associated with MG, MG corresponding to FR, and MG associated with FR.

In some embodiments, the one or more FRs include a first FR and a second FR; and
the total positioning measurement time T_{Y,Total} is determined according to max(T_{Y,FR1}+T_{guard,FR1}, T_{Y,FR2}+T_{guard,FR2});
where T_{Y,FR1} is the measurement time of measuring Y in the first FR, or the measurement time of measuring Y in the first FR MG, or the measurement time of measuring Y in the first FR PPW;
T_{Y,FR2} is the measurement time of measuring Y in the second FR, or the measurement time of measuring Y in the second FR MG, or the measurement time of measuring Y in the second FR PPW;
T_{guard,FR1} is second time corresponding to the first FR, and T_{guard,FR1} is the maximum T_{effect} among all positioning frequency layers in the first FR, T_{effect} being the period of Y measurement for each positioning frequency layer;
T_{guard,FR2} is second time corresponding to the second FR, and T_{guard,FR2} is the maximum T_{effect} among all positioning frequency layers in the second FR; and
Y includes at least one of: PRS RSTD, RSRP for PRS, reference signal received path power (RSRPP) for PRS, or Rx-Tx time difference.

Optionally, T_{guard,FR1} is the maximum T_{effect} among all positioning frequency layers in the first FR MG; alternatively, T_{guard,FR1} is the maximum T_{effect} among all positioning frequency layers in the first FR PPW; alternatively, T_{guard,FR1} is the maximum T_{effect} among all positioning frequency layers in the first FR MG and the first FR PPW.

Optionally, T_{guard,FR2} is the maximum T_{effect} among all positioning frequency layers in the second FR MG; alternatively, T_{guard,FR2} is the maximum T_{effect} among all positioning frequency layers in the second FR PPW; alternatively, T_{guard,FR2} is the maximum T_{effect} among all positioning frequency layers in the second FR MG and the second FR PPW.

Optionally, the total positioning measurement time T_{Y,Total} max(T_{Y,FR1}+T_{guard,FR1}, T_{Y,FR2}+T_{guard,FR2}).

For example, Y includes the PRS RSTD, and the total positioning measurement time T_{RSTD,Total} is determined according to max(T_{RSTD,FR1}+T_{guard,FR1}, T_{RSTD,FR2}+T_{guard,FR2}).

For example, T_{RSTD,Total}=max(T_{RSTD,FR1}+T_{guard,FR1}, T_{RSTD,FR2}+T_{guard,FR2}).

In some embodiments, T_{Y,FR1} and T_{Y,FR2} are determined according to the following formulas:

$${T}_{Y , FR 1} = {\sum }_{i = 1}^{L \_ FR 1} {T}_{Y , i , FR 1} + ( L\_FR1 - 1 ) * max ( {T}_{effect , i} ) ; \\ and \\ {T}_{Y , FR 2} = {\sum }_{i = 1}^{L \_ FR 2} {T}_{Y , i , FR 2} + ( L\_FR2 - 1 ) * max ( {T}_{effect , i} )$$

where i is an index of a positioning frequency layer;
L_FR1 is a total number of positioning frequency layers of the first FR;
L_FR2 is a total number of positioning frequency layers of the second FR; and
T_{effect,i} is a period of Y measurement in a positioning frequency layer i.

In some embodiments, the terminal device determining the total positioning measurement time according to the maximum value among the one or more periods of first positioning measurement time includes:

the terminal device determining the total positioning measurement time according to third positioning measurement time corresponding to a PPW and a maximum value among one or more periods of first positioning measurement time corresponding to one or more FR MGs.

Optionally, positioning measurement times corresponding to different FR MGs may be the same or different.

Optionally, positioning measurement times corresponding to different FR PPWs may be the same or different.

Optionally, in any one of the embodiments of the present disclosure, FR PPW may be replaced with one of: PPW FR, FR corresponding to PPW, FR associated with PPW, PPW corresponding to FR, and PPW associated with FR.

Optionally, the one or more FR MGs are in one-to-one to correspondence with the one or more periods of first positioning measurement time.

Optionally, the terminal device determines the total positioning measurement time according to a sum of the positioning measurement time corresponding to the PPW and the maximum value among the one or more periods of first positioning measurement time corresponding to the one or more FR MGs.

Optionally, the terminal device determines the total positioning measurement time according to a larger value between the positioning measurement time corresponding to the PPW and the maximum value among the one or more periods of first positioning measurement time corresponding to the one or more FR MGs.

In some embodiments, the third positioning measurement time corresponding to the PPW includes a maximum value of at least one positioning measurement time corresponding to at least one FR PPW.

Optionally, the maximum value of the at least one positioning measurement time corresponding to the at least one FR PPW may include: the maximum value of the at least one positioning measurement time in one-to-one correspondence with the at least one FR PPW.

Optionally, in any one of the embodiments of the present disclosure, the at least one FR may be the same as multiple FRs; alternatively, the at least one FR may be included in the multiple FRs; alternatively, the multiple FRs may be included in the at least one FR; alternatively, part of the at least one FR may overlap with part of the multiple FRs; alternatively, any one of the at least one FR may not overlap with any one of the multiple FRs.

For example, the at least one FR as well as the multiple FRs include a first FR and a second FR. For another example, the at least one FR includes the first FR, and the multiple FRs include the first FR and the second FR. For another example, the multiple FRs include the second FR, and the at least one FR includes the first FR and the second FR. For another example, the at least one FR includes the first FR and the second FR, and the multiple FRs include the first FR and a third FR. For another example, the at least one FR includes the first FR and the second FR, and the multiple FRs include the third FR and a fourth FR.

Optionally, in a case where the at least one FR PPW includes one FR PPW, the positioning measurement time corresponding to the PPW includes: one positioning measurement time corresponding to the one FR PPW. Optionally, in the case that the at least one FR PPW includes at least two FR PPWs, the positioning measurement time corresponding to the PPW includes: a maximum value of at least two positioning measurement times in one-to-one correspondence with the at least two FR PPWs.

In some embodiments, the third positioning measurement time corresponding to the PPW includes:

a sum of the at least one positioning measurement time corresponding to the at least one FR PPW.

Optionally, the sum of the at least one positioning measurement time corresponding to the at least one FR PPW may include: the sum of the at least one positioning measurement time in one-to one correspondence with the at least one FR PPW.

Optionally, in the case where the at least one FR PPW includes one FR PPW, the positioning measurement time corresponding to the PPW includes one positioning measurement time corresponding to the one FR PPW. Optionally, in the case where the at least one FR PPW includes at least two FR PPWs, the positioning measurement time corresponding to the PPW includes: a sum of at least two positioning measurement times in one-to-one correspondence with the at least two FR PPWs.

In some embodiments, the terminal device determining the total positioning measurement time according to the third positioning measurement time corresponding to the PPW and the maximum value among the one or more periods of first positioning measurement time corresponding to the one or more FR MGs includes:

the terminal device determining the total positioning measurement time according to the third positioning measurement time, the first time, and the maximum value among the one or more periods of first positioning measurement time corresponding to the one or more FR MGs.

Optionally, the one or more FR MGs are in one-to-one correspondence with the one or more periods of first positioning measurement time.

Optionally, values of the first time in different embodiments may be the same or different.

Optionally, the terminal device determines the total positioning measurement time according to the sum of the third positioning measurement time, the first time, and the maximum value among the one or more periods of first positioning measurement time corresponding to the one or more FR MGs.

Optionally, the terminal device determines the total positioning measurement time according to the first time plus a larger value between the third positioning measurement time and the maximum value among the one or more periods of first positioning measurement time corresponding to the one or more FR MGs.

In some embodiments, the terminal device determining the total positioning measurement time according to the third positioning measurement time corresponding to the PPW and the maximum value among the one or more periods of first positioning measurement time corresponding to the one or more FR MGs includes:

the terminal device determining the total positioning measurement time according to the sum of the third positioning measurement time and the maximum value among the one or more periods of first positioning measurement time corresponding to the one or more FR MGs.

In some embodiments, the terminal device determining the total positioning measurement time according to the third positioning measurement time corresponding to the PPW and the maximum value among the one or more periods of first positioning measurement time corresponding to the one or more FR MGs includes:

the terminal device determining the total positioning measurement time according to the sum of the third positioning measurement time, the first time, and the maximum value among the one or more periods of first positioning measurement time corresponding to the one or more FR MGs.

In some embodiments, the first positioning measurement time and/or the total positioning measurement time and/or the second positioning measurement time and/or the third positioning measurement time include at least one of:
measurement time of PRS reference signal time difference (RSTD) measurement;
reference signal received power (RSRP) for PRS;
measurement time of reference signal received path power (RSRPP) for PRS measurement;
measurement time of Rx-Tx time difference measurement; or
measurement time for PRS phase measurement.

It will be noted that forms included by the first positioning measurement time and/or the total positioning measurement time and/or the second positioning measurement time and/or the third positioning measurement time are listed above, but the present disclosure is not limited thereto. The first positioning measurement time and/or the total positioning measurement time and/or the second positioning measurement time and/or the third positioning measurement time may include measurement time of other positioning measurement.

Optionally, the measurement time of other positioning measurement may include: measurement time of a measurement agreed upon in a protocol other than the above measurements. Optionally, the measurement agreed upon in the protocol may be a measurement agreed upon in the protocol prior to the present disclosure, or may be a measurement agreed upon in the protocol after the present disclosure. For example, a new measurement is added into the protocol after the present disclosure, and the positioning measurement time in the present disclosure also includes measurement time in the new measurement.

In some embodiments, the one or more FRs include the first FR and the second FR; and
the total positioning measurement time T_{Y,Total} is determined according to one of:

$$max ( {T}_{Y , FR 1 , MG} , {T}_{Y , FR 2 , MG} ) + {T}_{Y , PPW} ;$$

$$max ( {T}_{Y , FR 1 , MG} , {T}_{Y , FR 2 , MG} ) + {T}_{Y , PPW} + {T}_{guard} ;$$

$$max ( {T}_{Y , FR 1 , MG} , {T}_{Y , FR 2 , MG} ) + max ( {T}_{Y , FR 1 , PPW} , {T}_{Y , FR 2 , PPW} ) ;$$

$$max ( {T}_{Y , FR 1 , MG} , {T}_{Y , FR 2 , MG} ) + max ( {T}_{Y , FR 1 , PPW} , {T}_{Y , FR 2 , PPW} ) + {T}_{guard} ;$$

$$max ( {T}_{Y , FR 1 , MG} , {T}_{Y , FR 2 , MG} ) + {T}_{Y , FR 1 , PPW} + {T}_{Y , FR 2 , PPW} ;$$

$$and$$

$$max ( {T}_{Y , FR 1 , MG} , {T}_{Y , FR 2 , MG} ) + {T}_{Y , FR 1 , PPW} + {T}_{Y , FR 2 , PPW} + {T}_{gu ard} ;$$

where T_{Y,FR1,MG} is the measurement time of measuring Y in the first FR MG;
T_{Y,FR2,MG} is measurement time of measuring Y in the second FR MG;
T_{Y,PPW} is measurement time of measuring Y within a PPW;
T_{guard} is the first time, T_{guard} is the maximum T_{effect} among all positioning frequency layers, and T_{effect} is a period of Y measurement for each positioning frequency layer;
T_{Y,FR1,PPW} is measurement time of measuring Y in the first FR PPW;
T_{Y,FR2,PPW} is measurement time of measuring Y in the second FR PPW; and
Y includes at least one of: PRS RSTD, RSRP for PRS, reference signal received path power (RSRPP) for PRS, or Rx-Tx time difference.

Optionally, T_{guard} may be determined according to max(T_{guard,FR1}, T_{guard,FR2}). For example, T_{guard}=max(T_{guard,FR1}, T_{guard,FR2}).

$$Optionally , {T}_{Y , Total} = max ( {T}_{Y , FR 1 , MG} , {T}_{Y , FR 2 , MG} ) + {T}_{Y , PPW} . \\ Optionally , {T}_{Y , Total} = max ( {T}_{Y , FR 1 , MG} , {T}_{Y , FR 2 , MG} ) + {T}_{Y , PPW} + {T}_{guard} . \\ Optionally , {T}_{Y , Total} = max ( {T}_{Y , FR 1 , MG} , {T}_{Y , FR 2 , MG} ) + max ( {T}_{Y , FR 1 , PPW} , {T}_{Y , FR 2 , PPW} ) . \\ Optionally , {T}_{Y , Total} = max ( {T}_{Y , FR 1 , MG} , {T}_{Y , FR 2 , MG} ) + max ( {T}_{Y , FR 1 , PPW} , {T}_{Y , FR 2 , PPW} ) + {T}_{guard} . \\ Optionally , {T}_{Y , Total} = max ( {T}_{Y , FR 1 , MG} , {T}_{Y , FR 2 , MG} ) + {T}_{Y , FR 1 , PPW} + {T}_{Y , FR 2 , PPW} . \\ Optionally , {T}_{Y , Total} = max ( {T}_{Y , FR 1 , MG} , {T}_{Y , FR 2 , MG} ) + {T}_{Y , FR 1 , PPW} + {T}_{Y , FR 2 , PPW} + {T}_{guard} .$$

For example, Y includes the PRS RSTD, and the total positioning measurement time T_{RSTD,Total} is determined according to one of:

$$max ( {T}_{RSTD , FR 1 , MG} , {T}_{RSTD , FR 2 , MG} ) + {T}_{RSTD , PPW} ; \\ max ( {T}_{RSTD , FR 1 , MG} , {T}_{RSTD , FR 2 , MG} ) + {T}_{RSTD , PPW} + {T}_{guard} ; \\ max ( {T}_{RSTD , FR 1 , MG} , {T}_{RSTD , FR 2 , MG} ) + max ( {T}_{RSTD , FR 1 , PPW} , {T}_{RSTD , FR 2 , PPW} ) ; \\ max ( {T}_{RSTD , FR 1 , MG} , {T}_{RSTD , FR 2 , MG} ) + max ( {T}_{RSTD , FR 1 , PPW} , {T}_{RSTD , FR 2 , PPW} ) + {T}_{guard} ; \\ max ( {T}_{RSTD , FR 1 , MG} , {T}_{RSTD , FR 2 , MG} ) + {T}_{RSTD , FR 1 , PPW} + {T}_{RSTD , FR 2 , PPW} ; \\ and \\ max ( {T}_{RSTD , FR 1 , MG} , {T}_{RS TD , FR 2 , MG} ) + {T}_{RSTD , FR 1 , PPW} + {T}_{RSTD , FR 2 , PPW} + {T}_{guard} ; \\ Optionally , {T}_{RSTD , Total} = max ( {T}_{RSTD , FR 1 , MG} , {T}_{RSTD , FR 2 , MG} ) + {T}_{RSTD , PPW} . \\ Optionally , {T}_{RSTD , Total} = max ( {T}_{RSTD , FR 1 , MG} , {T}_{RSTD , FR 2 , MG} ) + {T}_{RSTD , PPW} + {T}_{guard} . \\ Optionally , {T}_{RSTD , Total} = max ( {T}_{RSTD , FR 1 , MG} , {T}_{RSTD , FR 2 , MG} ) + max ( {T}_{RSTD , FR 1 , PPW} , {T}_{RSTD , FR 2 , PPW} ) . \\ Optionally , {T}_{RSTD , Total} = max ( {T}_{RSTD , FR 1 , MG} , {T}_{RSTD , FR 2 , MG} ) + max ( {T}_{RSTD , FR 1 , PPW} , {T}_{RSTD , FR 2 , PPW} ) + {T}_{guard} . \\ Optionally , {T}_{RSTD , Total} = max ( {T}_{RSTD , FR 1 , MG} , {T}_{RSTD , FR 2 , MG} ) + {T}_{RSTD , FR 1 , PPW} + {T}_{RSTD , FR 2 , PPW} . \\ Optionally , {T}_{RSTD , Total} = max ( {T}_{RSTD , FR 1 , MG} , {T}_{RSTD , FR 2 , MG} ) + {T}_{RSTD , FR 1 , PPW} + {T}_{RSTD , FR 2 , PPW} + {T}_{guard}$$

In some embodiments, first positioning measurement time corresponding to each FR is determined according to measurement time of measuring Y in each FR MG and/or measurement time of measuring Y in each FR PPW.

In some embodiments, the first positioning measurement time corresponding to each FR is determined according to the measurement time of measuring Y in each FR MG and/or the measurement time of measuring Y in each FR PPW, and the first time.

In some embodiments, the first positioning measurement time corresponding to each FR is determined according to the measurement time of measuring Y in each FR MG and/or the measurement time of measuring Y in each FR PPW, and second time corresponding to each FR.

Y includes at least one of: PRS RSTD, RSRP for PRS, reference signal received path power (RSRPP) for PRS, or Rx-Tx time difference.

Optionally, each FR is in one-to-one correspondence with each FR MG and/or each FR PPW.

For example, first positioning measurement time corresponding to an m-th FR is determined according to measurement time of measuring Y in an m-th FR MG and/or measurement time of measuring Y in an m-th FR PPW, m being an integer greater than or equal to 1.

Optionally, values of second times corresponding to different FRs may be the same or different.

For example, the first positioning measurement time corresponding to the m-th FR is determined according to the measurement time of measuring Y in the m-th FR MG and/or the measurement time of measuring Y in the m-th FR PPW, and the first time.

Optionally, each FR is in one-to-one correspondence with each FR MG and/or each FR PPW, and each FR is in one-to-one correspondence with each first time. Optionally, different FRs correspond to different first times, and the different first times may be the same or different.

For example, the first positioning measurement time corresponding to the m-th FR is determined according to the measurement time of measuring Y in the m-th FR MG and/or the measurement time of measuring Y in the m-th FR PPW, and an m-th first time. The m-th FR is in one-to-one correspondence with the m-th first time.

Optionally, for a single FR, if the single FR corresponds to an MG and does not correspond to a PPW (in other words, an MG measurement is supported and a PPW measurement is not supported), the first positioning measurement time corresponding to the single FR is determined according to the measurement time of measuring Y in the single FR MG (for example, the first positioning measurement time corresponding to the single FR is the measurement time of measuring Y in the single FR MG); alternatively, the first positioning measurement time corresponding to the single FR is determined according to the measurement time of measuring Y in the single FR MG and the first time (for example, the first positioning measurement time corresponding to the single FR is the sum of the measurement time of measuring Y in the single FR MG and the first time); alternatively, the first positioning measurement time corresponding to the single FR is determined according to the measurement time of measuring Y in the single FR MG and the second time corresponding to the single FR (for example, the first positioning measurement time corresponding to the single FR is the sum of the measurement time of measuring Y in the single FR MG and the second time corresponding to the single FR).

Optionally, for a single FR, if the single FR corresponds to a PPW and does not correspond to an MG (in other words, the PPW measurement is supported and the MG measurement is not supported), the first positioning measurement time corresponding to the single FR is determined according to the measurement time of measuring Y in the single FR PPW (for example, the first positioning measurement time corresponding to the single FR is the measurement time of measuring Y in the single FR PPW); alternatively, the first positioning measurement time corresponding to the single FR is determined according to the measurement time of measuring Y in the single FR PPW and the first time (for example, the first positioning measurement time corresponding to the single FR is the sum of the measurement time of measuring Y in the single FR PPW and the first time); alternatively, the first positioning measurement time corresponding to the single FR is determined according to the measurement time of measuring Y in the single FR PPW and the second time corresponding to the single FR (for example, the first positioning measurement time corresponding to the single FR is the sum of the measurement time of measuring Y in the single FR PPW and the second time corresponding to the single FR).

Optionally, for a single FR, if the single FR corresponds to an MG and also corresponds to a PPW (in other words, the MG measurement is supported and the PPW measurement is supported), the first positioning measurement time corresponding to the single FR is determined according to the measurement time of measuring Y in the single FR MG and the measurement time of measuring Y in the single FR PPW (for example, the first positioning measurement time corresponding to the single FR is the sum of the measurement time of measuring Y in the single FR MG and the measurement time of measuring Y in the single FR PPW); alternatively, the first positioning measurement time corresponding to the single FR is determined according to the measurement time of measuring Y in the single FR MG, the measurement time of measuring Y in the single FR PPW, and the first time (for example, the first positioning measurement time corresponding to the single FR is the sum of the measurement time of measuring Y in the single FR MG, the measurement time of measuring Y in the single FR PPW, and the first time); alternatively, the first positioning measurement time corresponding to the single FR is determined according to the measurement time of measuring Y in the single FR MG and the measurement time of measuring Y in the single FR PPW, and the second time corresponding to the single FR (for example, the first positioning measurement time corresponding to the single FR is the sum of the measurement time of measuring Y in the single FR MG, the measurement time of measuring Y in the single FR PPW and the second time corresponding to the single FR).

In some embodiments, the first positioning measurement time corresponding to each FR is determined according to the sum of the measurement time of measuring Y in each FR MG and the measurement time of measuring Y in each FR PPW.

Optionally, the first positioning measurement time corresponding to each FR may be the sum of the measurement time of measuring Y in each FR MG and the measurement time of measuring Y in each FR PPW.

In some embodiments, the first positioning measurement time corresponding to each FR is determined according to the sum of the measurement time of measuring Y in each FR MG, the measurement time of measuring Y in each FR PPW, and the first time.

Optionally, the first positioning measurement time corresponding to each FR may be the sum of the measurement time of measuring Y in each FR MG, the measurement time of measuring Y in each FR PPW, and the first time.

In some embodiments, the first positioning measurement time corresponding to each FR is determined according to the sum of the measurement time of measuring Y in each FR MG, the measurement time of measuring Y in each FR PPW, and the second time corresponding to each FR.

Optionally, the first positioning measurement time corresponding to each FR may be the sum of the measurement time of measuring Y in each of the FR MGs, the measurement time of measuring Y in each FR PPW, and the second time corresponding to each FR.

Y includes at least one of: PRS RSTD, RSRP for PRS, reference signal received path power (RSRPP) for PRS, or Rx-Tx time difference.

In some embodiments, the one or more FRs include a first FR and a second FR; and
first positioning measurement time T_{Y,FR1} corresponding to the first FR is determined according to one of:

$$\begin{matrix}{T}_{Y , FR 1 , MG} + {T}_{Y , FR 1 , PPW} ; \\ {T}_{Y , FR 1 , MG} + {T}_{Y , FR 1 , PPW} + {T}_{guard , FR 1} ; and \\ {T}_{Y , FR 1 , MG} + {T}_{Y , FR 1 , PPW} + {T}_{guard} ;\end{matrix}$$

first positioning measurement time T_{Y,FR2} corresponding to the second FR is determined according to one of:

$$\begin{matrix}{T}_{Y , FR 2 , MG} + {T}_{Y , FR 2 , PPW} ; \\ {T}_{Y , FR 2 , MG} + {T}_{Y , FR 2 , PPW} + {T}_{guard , FR 2} ; and \\ {T}_{Y , FR 2 , MG} + {T}_{Y , FR 2 , PPW} + {T}_{guard} ;\end{matrix}$$

where T_{Y,FR1,MG} is measurement time of measuring Y in the first FR MG; and T_{Y,FR2}, MG is measurement time of measuring Y in the second FR MG;
T_{Y,FR1,PPW} is measurement time of measuring Y in the first FR PPW; and T_{Y,FR2},PPW is measurement time of measuring Y in the second FR PPW;
T_{guard,FR1} is second time corresponding to the first FR, T_{guard,FR1} is a maximum T_{effect} among all positioning frequency layers in the first FR, and T_{guard,FR1} is a period of Y measurement for each positioning frequency layer; T_{guard,FR2} is second time corresponding to the second FR, and T_{guard,FR2} is a maximum T_{effect} among all positioning frequency layers in the second FR;
T_{guard} is the first time, and T_{guard} is a maximum T_{effect} among all positioning frequency layers; and
Y includes at least one of: PRS RSTD, RSRP for PRS, reference signal received path power (RSRPP) for PRS, or Rx-Tx time difference.

$$\begin{matrix}Optionally , {T}_{Y , F R 1} = {T}_{Y , F R 1 , M G} + {T}_{Y , FR 1 , P P W} . \\ Optionally , {T}_{Y , F R 1} = {T}_{Y , F R 1 , M G} + {T}_{Y , FR 1 , P P W} + {T}_{guard , FR 1} . \\ Optionally , {T}_{Y , F R 1} = {T}_{Y , F R 1 , M G} + {T}_{Y , FR 1 , P P W} + {T}_{guard} . \\ Optionally , {T}_{Y , FR 2} = {T}_{Y , FR 2 , MG} + {T}_{Y , FR 2 , PPW} . \\ Optionally , {T}_{Y , FR 2} = {T}_{Y , FR 2 , MG} + {T}_{Y , FR 2 , PPW} + {T}_{guard , FR 2} . \\ Optionally , {T}_{Y , FR 2} = {T}_{Y , FR 2 , MG} + {T}_{Y , FR 2 , PPW} + {T}_{guard} .\end{matrix}$$

For example, Y includes the PRS RSTD, and the first positioning measurement time T_{RSTD,FR1} corresponding to the first FR is determined according to one of:

$$\begin{matrix}{T}_{RSTD , FR 1 , MG} = {T}_{RSTD , FR 1 , PPW} ; \\ {T}_{RSTD , FR 1 , MG} = {T}_{RSTD , FR 1 , PPW} + {T}_{guard , FR 1} ; and \\ {T}_{RSTD , FR 1 , MG} = {T}_{RSTD , FR 1 , PPW} + {T}_{guard} .\end{matrix}$$

For example, Y includes the PRS RSTD, and the first positioning measurement time T_{RSTD,FR2} corresponding to the second FR is determined according to one of:

$$\begin{matrix}{T}_{RSTD , FR 2 , MG} = {T}_{RSTD , FR 2 , PPW} ; \\ {T}_{RSTD , FR 2 , MG} = {T}_{RSTD , FR 2 , PPW} + {T}_{guard , FR 2} ; and \\ {T}_{RSTD , FR 2 , MG} = {T}_{RSTD , FR 2 , PPW} + {T}_{guard} .\end{matrix}$$

$$\begin{matrix}Optionally , {T}_{RSTD , FR 1} = {T}_{RSTD , FR 1 , M G} + {T}_{RSTD , FR 1 , P P W} . \\ Optionally , {T}_{RSTD , FR 1} = {T}_{RSTD , FR 1 , M G} + {T}_{RSTD , FR 1 , P P W} + {T}_{guard , FR 1} . \\ Optionally , {T}_{RSTD , FR 1} = {T}_{RSTD , FR 1 , M G} + {T}_{RSTD , FR 1 , P P W} + {T}_{guard} . \\ Optionally , {T}_{RSTD , FR 2} = {T}_{RSTD , FR 2 , MG} + {T}_{RSTD , FR 2 , PPW} . \\ Optionally , {T}_{RSTD , FR 2} = {T}_{RSTD , FR 2 , MG} + {T}_{RSTD , FR 2 , PPW} + {T}_{guard , FR 2} . \\ Optionally , {T}_{RSTD , FR 2} = {T}_{RSTD , FR 2 , MG} + {T}_{RSTD , FR 2 , PPW} + {T}_{guard} .\end{matrix}$$

In some embodiments, T_{Y,FR1,MG} and T_{Y,FR2,MG} are determined according to the following formulas:

$$\begin{matrix}{T}_{Y , FR 1 , M G} = {\sum }_{i = 1}^{{L\_FR 1}^{′}} {T}_{Y , i , F R 1} + ( {L\_FR1}^{′} - 1 ) * max ( {T}_{effect , i} ) ; and \\ {T}_{Y , FR 2 , MG} = {\sum }_{i = 1}^{{L\_FR 2}^{′}} {T}_{Y , i , FR 2} + ( {L\_FR2}^{′} - 1 ) * max ( {T}_{effect , i} ) ;\end{matrix}$$

where i is an index of the positioning frequency layer;
L_FR1′ is a total number of positioning frequency layers for MG-based measurement in the first FR;
L_FR2′ is a total number of positioning frequency layers for MG-based measurement in the second FR; and
T_{effect,i} is a period of Y measurement in the positioning frequency layer i.

For example, Y includes the PRS RSTD, and T_{RSTD,FR1,MG} and T_{RSTD,FR2,MG} are determined according to the following formulas:

$$\begin{matrix}{T}_{RSTD , FR 1 , M G} = {\sum }_{i = 1}^{{L\_FR 1}^{′}} {T}_{RSTD , i , F R 1} + ( {L\_FR1}^{′} - 1 ) * max ( {T}_{effect , i} ) ; and \\ {T}_{RSTD , FR 2 , MG} = {\sum }_{i = 1}^{{L\_FR 2}^{′}} {T}_{RSTD , i , FR 2} + ( {L\_FR2}^{′} - 1 ) * max ( {T}_{effect , i} ) .\end{matrix}$$

In some embodiments, T_{Y,i,FR1} and T_{Y,i,FR2} are determined according to the following formulas:

$${T}_{Y , i , FR 1} = ( {k}_{m u l t i T E G , i} * C S S {F}_{P R S , i , FR 1} * ceil ( {K}_{p , P R S , i} ) * {N}_{RxBeam , i} * ⌈ \frac{{N}_{PRS , i}^{slot}}{{N}^{′}} ⌉ ⌈ \frac{{L}_{available\_PRS , i}}{N} ⌉ * {N}_{s a m p l e} - 1 ) * {T}_{effect , i} + {T}_{l a s t , i} ; and$$

$${T}_{Y , i , FR 2} = ( {k}_{m u l t i T E G , i} * C S S {F}_{P R S , i , FR 2} * ceil ( {K}_{p , P R S , i} ) * {N}_{RxBeam , i} * ⌈ \frac{{N}_{PRS , i}^{slot}}{{N}^{′}} ⌉ ⌈ \frac{{L}_{available\_PRS , i}}{N} ⌉ * {N}_{s a m p l e} - 1 ) * {T}_{effect , i} + {T}_{l a s t , i} ; where$$

N_{RxBeam,i} is a receive (Rx) beam scanning factor of the terminal device;
CSSF_{PRSi,FR1} is a carrier specific scaling factor of positioning measurement based on a new radio (NR) PRS in a positioning frequency layer i of the first FR, and CSSF_{PRSi,FR2} is a carrier specific scaling factor of positioning measurement based on the NR PRS in a positioning frequency layer i of the second FR;
k_{multiTEG,i} is a scaling factor for measuring the same PRS resource having multiple Rx time error groups (TEGs);
K_{p,PRS,i} is a scaling factor of a positioning frequency layer to be measured within an associated measurement gap pattern;

$${N}_{PRS , i}^{slot}$$

is a maximum number of downlink (DL) PRS resources in a positioning frequency layer i configured in one slot;
N is duration of a DL PRS symbol, measured in ms;
L_{available_PRS,i} is duration of available PRS in a positioning frequency layer i to be measured during T_{available_PRS,i}; T_{available_PRS,i}=LCM(T_{PRS,i}, T_{DRX}), where LCM(T_{PRS,i} T_{DRX}) is a least common multiple of T_{PRS,i} and a DRX period TORX, and T_{PRS,i} is a period of silent DL PRS resources on the positioning frequency layer i;
N′ is a capability for which the terminal device is capable of processing a number of DL PRS resources in one slot;
Nₛₐₘₚₗₑ is a number of samples of Y measurement;
T_{effect,i} is a period of Y measurement in the positioning frequency layer i; and
T_{last,i} is measurement duration for a last PRS RSTD sample in the positioning frequency layer i.

For example, Y includes the PRS RSTD, and T_{RSTD,i,FR1} and T_{RSTD,i,FR2} are determined according to the following formulas:

$${T}_{RSTD , i , FR 1} = ( {k}_{m u l t i T E G , i} * C S S {F}_{P R S , i , FR 1} * ceil ( {K}_{p , P R S , i} ) * {N}_{RxBeam , i} * ⌈ \frac{{N}_{PRS , i}^{slot}}{{N}^{′}} ⌉ ⌈ \frac{{L}_{available\_PRS , i}}{N} ⌉ * {N}_{s a m p l e} - 1 ) * {T}_{effect , i} + {T}_{l a s t , i} ; and$$

$${T}_{RSTD , i , FR 2} = ( {k}_{m u l t i T E G , i} * C S S {F}_{P R S , i , FR 2} * ceil ( {K}_{p , P R S , i} ) * {N}_{RxBeam , i} * ⌈ \frac{{N}_{PRS , i}^{slot}}{{N}^{′}} ⌉ ⌈ \frac{{L}_{available\_PRS , i}}{N} ⌉ * {N}_{s a m p l e} - 1 ) * {T}_{effect , i} + {T}_{l a s t , i} ;$$

In some embodiments, T_{Y,FR1}, PPW and T_{Y,FR2,PPW} are determined according to the following formulas:

$$\begin{matrix}{T}_{Y , FR 1 , P P W} = {\sum }_{i = 1}^{{L\_FR 1}^{″}} {T}_{Y\_wo \_gap , i} + ( {L\_FR1}^{″} - 1 ) * max ( {T}_{effect , i} ) ; and \\ {T}_{Y , FR 2 , PPW} = {\sum }_{i = 1}^{L\_FR {2}^{″}} {T}_{Y\_wo \_gap , i} + ( {L\_FR2}^{″} - 1 ) * max ( {T}_{effect , i} ) ;\end{matrix}$$

where i is an index of a positioning frequency layer;
L_FR1″ is a total number of positioning frequency layers for PPW-based measurement in a first FR;
L_FR2″ is a total number of positioning frequency layers for PPW-based measurement in a second FR; and
T_{effect,i} is a period of Y measurement in the positioning frequency layer i.

Optionally, L_FR1 may include L_FR1′ and/or L_FR1′, and L_FR2 may include L_FR2′ and/or L_FR2″. Optionally, any two of L_FR1, L_FR1′ and L_FR1″ may be the same or different, and any two of L_FR2, L_FR2′, and L_FR2″ may be the same or different.

For example, Y includes the PRS RSTD, and T_{RSTD,FR1,PPW} and T_{RSTD,FR2,PPW} are determined according to the following formulas:

T_{RSTD,FR1,PPW}=Σᵢ₌₁^{L_FR1″}T_{RSTD_wo_gap,i}+(L_FR1″−1)*max(T_{effect,i}); and

T_{RSTD,FR2,PPW}=Σᵢ₌₁^{L_FR2″}T_{RSTD_wo_gap,i}+(L_FR2″−1)*max(T_{effect,i})

In some embodiments, T_{Y_wo_gap,i} is determined according to the following formula:

$${T}_{Y\_wo \_gap , i} = ( {k}_{m u l t i T E G , i} * {N}_{RxBeam , i} * ⌈ \frac{{N}_{PRS , i}^{slot}}{{N}^{′}} ⌉ ⌈ \frac{{L}_{available\_PRS , i}}{N} ⌉ * {N}_{sample} - 1 ) * {T}_{effect , i} + {T}_{l a s t , i} ;$$

where k_{multiTEG,i} is a scaling factor for measuring a same PRS resource having multiple Rx time error groups (TEGs);
N_{RxBeam,i} is a receive (Rx) beam scanning factor of the terminal device;

$${N}_{P R S , i}^{slot}$$

is the maximum number of downlink (DL) PRS resources in the positioning frequency layer i configured in one slot;
N is duration of a DL PRS symbol, measured in ms;
L_{available_PRS,i} is duration of available PRS in the positioning frequency layer i to be measured during T_{available_PRS,i}; T_{available_PRS,i}=LCM(T_{PRS,i}, MGRP), where LCM(T_{PRS,i}, MGRP) is a least common multiple of T_{PRS,i} and a MG repetition period (MGRP), and T_{PRS,i} is a period of silent DL PRS resources on the positioning frequency layer i;
N′ is a capability for which the terminal device is capable of processing a number of DL PRS resources in one slot;
Nₛₐₘₚₗₑ is a number of samples for Y measurement;
T_{effect,i} is a period of Y measurement in the positioning frequency layer i; and
T_{last,i} is measurement duration for a last Y sample in the positioning frequency layer i.

For example, Y includes the PRS RSTD, and T_{RSTD_wo_gap,i} is determined according to the following formula:

$${T}_{RSTD\_wo \_gap , i} = ( {k}_{m u l t i T E G , i} * {N}_{RxBeam , i} * ⌈ \frac{{N}_{PRS , i}^{slot}}{{N}^{′}} ⌉ ⌈ \frac{{L}_{available\_PRS , i}}{N} ⌉ * {N}_{sample} - 1 ) * {T}_{effect , i} + {T}_{l a s t , i} .$$

Optionally, the embodiments of the present disclosure may further provide a communication method, and the communication method includes:

a terminal device receiving indication information, where the indication information indicates that the first gap pattern corresponds to a per FR or per FR gap, or the indication information indicates that a first gap pattern corresponds to one or more per FRs/one or more per FR gaps. Optionally, the terminal device receiving the indication information may include the terminal device receiving the indication information transmitted by the network device.

Optionally, the embodiments of the present disclosure may further provide a communication method, and the communication method includes:
the terminal device receiving first information or second information;
where the first information indicates to configure a first gap pattern as a per FR type, or the first information indicates the first gap pattern as a per FR type configured in a corresponding FR; and
the second information indicates to configure one or more per FR gaps in multiple concurrent gaps as the first gap pattern.

Optionally, the indication information may include the first information or the second information.

Optionally, the terminal device receiving the first information or the second information may include the terminal device receiving the first information or the second information transmitted by the network device.

Optionally, the terminal device receiving the first information or the second information may include the terminal device receiving the first information or the second information in a case where the terminal device supports an independent gap configuration PRS capability.

FIG. 3 is a flowchart of another communication method provided in embodiments of the present disclosure. As shown in FIG. 3, the method includes the following step.

In S301, a terminal device receives first information in a case where the terminal device supports an independent gap configuration positioning reference signal (PRS) capability or in a case where the terminal device supports the independent gap configuration PRS capability and a first capability; or the terminal device receives second information in a case where the terminal device supports the independent gap configuration PRS capability and a second capability or in a case where the terminal device supports the independent gap configuration PRS capability, the first capability and the second capability.

The first capability indicates that the terminal device allows or supports configuring a first gap pattern as a per FR type, or the first capability indicates that the terminal device allows or supports the first gap pattern as a per FR type configured in a corresponding FR; the first gap pattern indicates a first measurement gap length (MGL) and a first measurement gap repetition period (MGRP).

The second capability indicates that the terminal device allows or supports configuring one or more first FR gaps in multiple concurrent gaps as the first gap pattern.

The first information indicates to configure the first gap pattern as the per FR type, or the first information indicates the first gap pattern as the per FR type configured in the corresponding FR.

The second information indicates to configure one or more first FR gaps in the multiple concurrent gaps as the first gap pattern.

Optionally, as for a relevant description of S301 and the following contents, reference may be made to the description of the above embodiments.

In some embodiments, the first gap pattern includes MG pattern 24 and/or MG pattern 25.

In some embodiments, a reporting manner of the first capability and/or the second capability is the same as a reporting manner of the independent gap configuration PRS capability.

In some embodiments, the first capability and the second capability are reported via first signaling. Alternatively, the first capability is reported via first signaling, and the second capability is reported via second signaling.

In some embodiments, the method further includes:

the terminal device determining total positioning measurement time according to a maximum value among one or more periods of first positioning measurement time, where the one or more periods of first positioning measurement time correspond to one or more frequency ranges (FRs).

In some embodiments, the terminal device determining the total positioning measurement time according to the maximum value among the one or more periods of first positioning measurement time includes: the terminal device determining the total positioning measurement time according to first time and the maximum value among the one or more periods of first positioning measurement time.

In some embodiments, first positioning measurement time corresponding to each FR is determined according to measurement time of each FR and second time corresponding to each FR.

In some embodiments, the terminal device determining the total positioning measurement time according to the maximum value among the one or more periods of first positioning measurement time includes:
in a case where the terminal device supports an independent gap configuration positioning reference signal (PRS) capability and the terminal device is configured with one or more first FR gaps for PRS measurement, the terminal device determining the total positioning measurement time according to the maximum value among the one or more periods of first positioning measurement time; or
in a case where the terminal device supports a simultaneous processing of PRS for different FRs capability and the terminal device is configured with one or more first FR gaps for PRS measurement, the terminal device determining the total positioning measurement time according to the maximum value among the one or more periods of first positioning measurement time; or
in a case where the terminal device supports the independent gap configuration PRS capability and the simultaneous processing of PRS for different FRs capability and the terminal device is configured with one or more first FR gaps for PRS measurement, the terminal device determining the total positioning measurement time according to the maximum value among the one or more periods of first positioning measurement time.

In some embodiments, the terminal device determining the total positioning measurement time according to the maximum value among the one or more periods of first positioning measurement time includes:

the terminal device determining the total positioning measurement time according to third positioning measurement time corresponding to a PRS processing window (PPW) and a maximum value among one or more periods of first positioning measurement time corresponding to one or more FR MGs.

In some embodiments, the first positioning measurement time and/or the total positioning measurement time and/or the second positioning measurement time and/or the third positioning measurement time includes at least one of:
measurement time of PRS reference signal time difference (RSTD) measurement;
reference signal received power (RSRP) for PRS;
measurement time of reference signal received path power (RSRPP) for PRS measurement;
measurement time of Rx-Tx time difference measurement; or
measurement time for PRS phase measurement.

In some embodiments, the first positioning measurement time corresponding to each FR is determined according to measurement time of measuring Y in each FR MG and/or measurement time of measuring Y in each FR PPW; or
the first positioning measurement time corresponding to each FR is determined according to the measurement time of measuring Y in each FR MG and/or the measurement time of measuring Y in each FR PPW, and according to first time or second time corresponding to each FR;
where Y includes at least one of: PRS RSTD, RSRP for PRS, reference signal received path power (RSRPP) of PRS, or Rx-Tx time difference.

FIG. 4 is a flowchart of yet another communication method provided in embodiments of the present disclosure. As shown in FIG. 4, the method includes the following step.

In S401, a network device configures one or more first frequency range (FR) gaps for positioning reference signal (PRS) measurement to a terminal device, where the one or more first FR gaps are used for PRS measurement and for the terminal device determining total positioning measurement time according to a maximum value among one or more periods of first positioning measurement time, the one or more periods of first positioning measurement time corresponding to one or more FRs.

In some embodiments, the network device configuring one or more first FR gaps for PRS measurement to the terminal device includes:

the network device configuring the one or more first FR gaps for PRS measurement for the terminal device in a case where the network device receives support for an independent gap configuration positioning reference signal (PRS) capability transmitted by the terminal device, or in a case where the network device receives support for a simultaneous processing of PRS for different FRs capability transmitted by the terminal device, or in a case where the network device receives the support for the independent gap configuration PRS capability and the support for the simultaneous processing of PRS for different FRs capability transmitted by the terminal device.

In some embodiments, the method further includes:
the network device configuring first information to the terminal device in a case where the network device receives the support for the independent gap configuration PRS capability transmitted by the terminal device or in a case where the network device receives support for the independent gap configuration PRS capability and a first capability transmitted by the terminal device; or
the network device configuring second information to the terminal device in a case where the network device receives support for the independent gap configuration PRS capability and a second capability transmitted by the terminal device or in a case where the network device receives support for the independent gap configuration PRS capability, the first capability, and the second capability transmitted by the terminal device; where
the first capability indicates that the terminal device allows or supports configuring a first gap pattern as a per FR type, or the first capability indicates that the terminal device allows or supports the first gap pattern as the per FR type configured in the corresponding FR; the first gap pattern indicates a first measurement gap length (MGL) and a first measurement gap repetition period (MGRP);
the second capability indicates that the terminal device allows or supports configuring one or more first FR gaps in multiple concurrent gaps as the first gap pattern;
the first information indicates to configure the first gap pattern as the per FR type, or the first information indicates the first gap pattern as the per FR type configured in the corresponding FR; and
the second information indicates to configure one or more first FR gaps in the multiple concurrent gaps as the first gap pattern.

In some embodiments, the first gap pattern includes MG pattern 24 and/or MG pattern 25.

Optionally, the embodiments of the present disclosure may further provide a communication method, and the communication method includes the following content.

A network device transmits indication information, where the indication information indicates that a first gap pattern corresponds to a per FR or per FR gap, or the indication information indicates that the first gap pattern corresponds to one or more per FRs/one or more per FR gaps. Optionally, the network device transmitting the indication information may include the network device transmitting the indication information to a terminal device.

Optionally, the embodiments of the present disclosure may further provide a communication method, and the communication method includes:
the network device transmitting first information or second information;
where the first information indicates to configure the first gap pattern as the per FR type, or the first information indicates the first gap pattern corresponds to a per FR configuration or a per FR type; and
the second information indicates to configure one or more per FR gaps in multiple concurrent gaps as the first gap pattern.

Optionally, the indication information may include the first information or the second information.

Optionally, the network device transmitting the first information or the second information may include: the network device transmitting the first information or the second information to the terminal device.

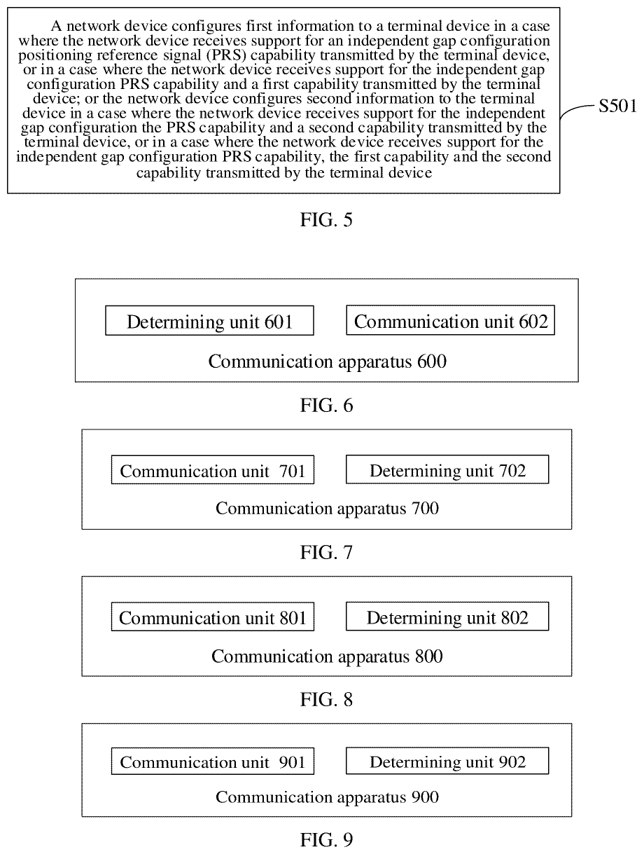

FIG. 5 is a flowchart of yet another communication method provided in embodiments of the present disclosure. As shown in FIG. 5, the method includes the following step.

In S501, a network device configures first information to a terminal device in a case where the network device receives support for an independent gap configuration positioning reference signal (PRS) capability transmitted by a terminal device or in a case where the network device receives support for the independent gap configuration PRS capability and a first capability transmitted by the terminal device; or the network device configures second information to the terminal device in a case where the network device receives support for the independent gap configuration PRS capability and a second capability transmitted by the terminal device or in a case where the network device receives support for the independent gap configuration PRS capability, the first capability, and the second capability transmitted by the terminal device.

The first capability indicates that the terminal device allows or supports configuring a first gap pattern as a per FR type, or the first capability indicates that the terminal device allows or supports the first gap pattern as a per FR type configured in a corresponding FR. The first gap pattern indicates a first measurement gap length (MGL) and a first measurement gap repetition period (MGRP).

The second capability indicates that the terminal device allows or supports configuring one or more first FR gaps in multiple concurrent gaps as the first gap pattern.

The first information indicates to configure the first gap pattern as the per FR type, or the first information indicates the first gap pattern as the per FR type configured in the corresponding FR.

The second information indicates to configure the one or more first FR gaps in the multiple concurrent gaps as the first gap pattern.

In some embodiments, the first gap pattern includes MG pattern 24 and/or MG pattern 25.

In some embodiments, the method further includes:

the network device configuring one or more first FR gaps for PRS measurement to the terminal device, where the one or more first FR gaps are used for PRS measurement and for the terminal device determining total positioning measurement time according to a maximum value among one or more periods of first positioning measurement time, the one or more periods of first positioning measurement time corresponding to one or more frequency ranges (FRs).

In some embodiments, the network device configuring the one or more first FR gaps for PRS measurement to the terminal device includes:

the network device configuring the one or more first FR gaps for PRS measurement to the terminal device in a case where the network device receives the support for the independent gap configuration positioning reference signal (PRS) capability transmitted by the terminal device, or in a case where the network device receives support for a simultaneous processing of PRS for different FRs capability transmitted by the terminal device, or in a case where the network device receives the support for the independent gap configuration PRS capability and the support for the simultaneous processing of PRS for different FRs capability transmitted by the terminal device.

It will be noted that, for a description of content in a certain embodiment, if there are identical or corresponding contents in other embodiments, the description of the content is also applicable to the contents in other embodiments.

Some embodiments of the present disclosure are described below.

In some embodiments, the terminal device may calculate positioning measurement time of different FRs (corresponding to the first positioning measurement time mentioned above), and take a maximum value (max-based) among the positioning measurement times as total measurement time (corresponding to the total positioning measurement time mentioned above).

Optionally, a T_{guard} (or a T_{margin}) may be added to the maximum value as total measurement time.

Optionally, in a case where the UE supports the independentGapConfigPRS-r17 capability and is configured with per FR gap for PRS measurement, PRS measurement time (corresponding to the total positioning measurement time) may be calculated using the max-based manner.

Optionally, in the max-based manner, the terminal device determines the total positioning measurement time according to the maximum value among multiple periods of first positioning measurement time in one-to-one correspondence with one or more FRs.

Optionally, in a sum-based manner, the terminal device determines the total positioning measurement time according to a sum of multiple periods of first positioning measurement time in one-to-one correspondence with one or more FRs.

Optionally, a new capability may be introduced to indicate whether to adopt the previous sum-based manner or the max-based manner proposed in the present solution. The new capability may be simulProcessingPrsDiffFR (or simultaneousPRSdiffFR). The following takes the simultaneousPRSdiffFR capability as an example for illustration.

Optionally, the introduced new capability simultaneousPRSdiffFR is independent of the previous independent gap capability independentGapConfigPRS-r17.

Optionally, independentGapConfigPRS-r17 indicates whether measuring PRS based on per FR gap is allowed. Optionally, simultaneousPRSdiffFR indicates whether a user (also referred to as terminal device or UE) is capable of simultaneously processing a PRS signal for different FRs.

Optionally, in a case where the two capabilities are supported (i.e., both the independentGapConfigPRS-r17 capability and the simultaneousPRSdiffFR capability are supported) and the per FR gap configured by a network is used for PRS measurement, the measurement time may be reduced by the manner (i.e., max-based) proposed in the present solution.

Optionally, in a case where only independentGapConfigPRS-r17 is supported (in other words, the independentGapConfigPRS-r17 capability is supported) and the simultaneousPRSdiffFR capability is not supported, even if the per FR gap is configured for the PRS measurement, the measurement time is still calculated using the sum-based manner in the related art. That is, frequency points of a positioning frequency layer (PFL) are all received and processed serially.

Optionally, the introduced new capability simultaneousPRSdiffFR is based on the previous independent gap capability independentGapConfigPRS-r17. That is, the UE supporting the independentGapConfigPRS-r17 capability is a precondition for supporting the simultaneousPRSdiffFR capability.

In some embodiments, in a case where the UE supports the independentGapConfigPRS-r17 capability, there are following solutions

Optionally, in a solution, a new capability is not required, and the network is allowed to configure MG pattern #24/25 as a per FR type (merely combining the two current capabilities/functions, without any protocol impact).

Optionally, in another solution, a new UE capability may be introduced to indicate whether MG pattern #24/25 is allowed to be configured as the per FR type. This means that whether the two capabilities/functions are combined needs to be supported by the introduced new capability.

Three embodiments are provided below to illustrate the embodiments of the present disclosure.

### Embodiment 1

In a case where the UE supports the independentGapConfigPRS-r17 capability, a corresponding positioning frequency layer may be measured independently in each FR, and measurements for different FRs may be performed simultaneously

Optionally, in a case where the UE does not support the independentGapConfigPRS-r17 capability, the total positioning measurement time is calculated using the sum-based method in the related art.

Optionally, in a case where the UE supports the independentGapConfigPRS-r17 capability, the measurement time needs to be calculated independently based on each FR, and the final total measurement time is a maximum value among the measurement times of all FRs.

A description is made below based on an assumption that reference signal time difference (RSTD) is measured and independent measurement for two frequency ranges FR1 (corresponding to the first FR) and FR2 (corresponding to the second FR) is supported. It will be noted that although the present solution takes the RSTD, the FR1 and the FR2 as examples, the present solution may also be applied to other measurements, such as reference signal received power (RSRP) measurement for PRS, reference signal received path power (RSRPP) measurement for PRS, or Rx-Tx time difference measurement, and calculations corresponding to other measurements are similar to the calculation corresponding to the RSTD measurement. In addition, the present solution may also use other FRs or other combinations of FRs. For example, the UE supports independent measurement for the FR1, the FR2 and a FR3; alternatively, the UE supports independent measurement for the FR1, a FR2-1 and a FR2-2, where the FR2 includes the FR2-1 and the FR2-2, and the FR2-1 is not overlapped with the FR2-2, which are not listed one by one in the embodiments of the present disclosure.

In some embodiments, the total positioning measurement time T_{RSTD,Total} is equal to max(T_{RSTD,FR1}, T_{RSTD,FR2}) i.e., T_{RSTD,Total}=max(T_{RSTD,FR1}, T_{RSTD,FR2}).

T_{RSTD,FR1} and T_{RSTD,FR2} may be measurement time in the FR1 and measurement time in the FR2, respectively; the measurement time is the sum of measurement times of all positioning frequency layers (PFLs) in the corresponding FR; and a carrier specific scaling factor (CSSF) of measurement time for each PFL is also calculated independently. Optionally, a T_{guard} may be added additionally to the above formula. For example, T_{RSTD,Total}=max(T_{RSTD,FR1}, T_{RSTD,FR2})+T_{guard}.

$${T}_{R S TD , FR 1} = {\sum }_{i = 1}^{L\_FR 1} {T}_{R S T D , i , F R 1} + ( L\_FR1 - 1 ) * max ( {T}_{effect , i} ) ; and$$

$${T}_{R S TD , FR 2} = {\sum }_{i = 1}^{L\_FR 2} {T}_{R S T D , i , FR 2} + ( L\_FR2 - 1 ) * max ( {T}_{effect , i} ) ;$$

$${T}_{R S T D , i , F R 1} = ( {k}_{m u l t i T E G , i} * C S S {F}_{P R S , i , F R 1} * ceil ( {K}_{p , P R S , i} ) * {N}_{R x B e a m , i} * ⌈ \frac{{N}_{{PRS}_{i}}^{slot}}{{N}^{′}} ⌉ ⌈ \frac{{L}_{available\_PRS , i}}{N} ⌉ * {N}_{s a m p l e} - 1 ) * {T}_{effect , i} + {T}_{{last ’}^{i}} ; and$$

$${T}_{R S T D , i , FR 2} = ( {k}_{m u l t i T E G , i} * C S S {F}_{P R S , i , FR 2} * ceil ( {K}_{p , P R S , i} ) * {N}_{R x B e a m , i} * ⌈ \frac{{N}_{PRS , i}^{slot}}{{N}^{′}} ⌉ ⌈ \frac{{L}_{available\_PRS , i}}{N} ⌉ * {N}_{s a m p l e} - 1 ) * {T}_{effect , i} + {T}_{last , i} .$$

In the embodiments of the present disclosure, the total positioning measurement time determined by the max-based manner is less than the total positioning measurement time determined by the sum-based manner. For example, it is assumed that the reference signal time difference (RSTD) measurement is configured with 2 positioning frequency layers (PFLs), and it is assumed that T_{effect,i}=80 ms, T_{last,i}=80 ms, k_{multiTEG,i}=1, K_{p,PRS,i}=1,

$$⌈ \frac{{N}_{{PRS}_{i}}^{slot}}{{N}^{′}} ⌉ ⌈ \frac{{L}_{available\_PRS , i}}{N} ⌉ = 1 , and ⌈ \frac{{N}_{{PRS}_{i}}^{slot}}{{N}^{′}} ⌉ ⌈ \frac{{L}_{available\_PRS , i}}{N} ⌉ = 4 ,$$

PFL #1 is within FR1, and PFL #2 is within FR2 (Rx beam sweep measured on FR1: N_{RxBeam,i}=1, and Rx beam sweep measured on FR2: N_{RxBeam,i}=8). In addition, the UE is also configured with one SSB frequency point on FR1.

In this way, according to the sum-based manner for calculating the measurement time, if CSSF_{PRS,i,FR1} of PFL #1 is equal to 2, and CSSF_{PRS,i,FR2} of PFL #2 is equal to 1, the total time is a sum of the two, where T_{RSTD,i,FR1}=(2*4−1)*80+80=640 ms and T_{RSTD,i,FR2}=(1*8*4−1)*80+80=2640 ms. The total positioning measurement time determined by the sum-based manner in the related art is T=T1+T2+max(T_{effect,i})=640+2640+80 ms=3360 ms. However, in the max-based manner of the present solution, a CSSF of PFL #1 is equal to 2, a CSSF of PFL #2 is equal to 1, and the total time is the maximum value between the two, where T1=(2*4−1)*80+80=640 ms and T2=(1*8*4−1)*80+80=2560 ms; therefore, the total positioning measurement time determined by the max-based manner in the present solution is T=max(T1, T2)=2560 ms, or the total positioning measurement time determined by the max-based manner in the present solution is T=max(T1, T2)+max(T_{effect,i})=2560+80=2640 ms. It can be seen from the example that, by using the max-based manner in the present solution, the measurement time for PRS may be reduced.

### Embodiment 2

It is assumed that, when the UE supports the independentGapConfigPRS-r17 capability, the corresponding positioning frequency layer may be measured independently in each FR, and measurements for different FRs may be performed simultaneously. In addition, it may also be combined with Option 2-1 or Option 2-2.

Option 2-1: assuming that only one positioning frequency layer (PFL) of an outside gap is measured at a same time point, a measurement within the measurement gap (MG) will be calculated based on the measurement in Embodiment 1, and all PFLs measured in the outside gap may be added.

$${T}_{RSTD , Total} = max ( {T}_{R S TD , FR 1 , MG} , {T}_{R S TD , FR 2 , MG} ) + {T}_{RSTD , PPW} + {T}_{guard} .$$

Option 2-2: assuming that positioning frequency layers (PFLs) of the outside gap for different frequency ranges (FRs) may be processed simultaneously, PRS measurement time for the within gap and PRS measurement time for the outside gap may be calculated separately based on each frequency point, for example:

$$\begin{matrix}{T}_{R S T D , Total} = max ( {T}_{RSTD , FR 1} , {T}_{RSTD , FR 2} ) ; where \\ {T}_{R S TD , FR 1} = {T}_{R S TD , FR 1 , MG} + {T}_{R S TD , FR 1 , PPW} + {T}_{guard , FR 1} ; and \\ {T}_{R S TD , FR 2} = {T}_{R S TD , FR 2 , MG} + {T}_{R S TD , FR 2 , PPW} + {T}_{guard , FR 2} .\end{matrix}$$

### Embodiment 3

It is assumed that the UE supporting the independentGapConfigPRS-r17 capability may correspond to Option 3-1 or Option 3-2.

Option 3-1: MG #24 and #25 may be configured as per FR types (if the user supports a corresponding gap pattern), which includes per FR gap in Rel-16 and any per FR gap in the concurrent gap combination supported by Rel-17.

Option 3-2: in addition to the independentGapConfigPRS-r17 capability, a new user capability independentGapConfigPRS2425_v1 is introduced (a name of specific signaling may be different). A reporting manner and process of the independentGapConfigPRS2425_v1 capability is consistent with that of the independentGapConfigPRS-r17, and the independentGapConfigPRS2425_v1 capability is used to indicate that MG #24 and #25 can be configured as the per FR types. In addition, a new user capability independentGapConfigPRS2425_v2 may be introduced to indicate whether any per FR gap in the gap combination is allowed to be configured as MG #24/#25 when the user supports a concurrent gap capability.

Optionally, the independentGapConfigPRS2425_v1 capability and the independentGapConfigPRS2425_v2 capability may be indicated by a same piece of signaling (that is, one piece of signaling indicates whether the above two situations are supported), or indicated by two different pieces of signaling.

In the embodiments of the present disclosure, when the user supports the capability of per FR gap for PRS, the present disclosure provides a solution for determining a maximum value of positioning measurement time based on each FR as the total measurement time, which may reduce the time required for PRS measurement.

In addition, in the embodiments of the present disclosure, a rule is provided for determining whether MG pattern #24/25 is allowed to be configured as a per FR type, and whether the MG pattern #24/25 being of the per FR type is allowed to be configured as a per FR gap in a concurrent gap.

In the embodiments of the present disclosure, based on the per FR PRS gap and/or the simultaneous processing of PRS for different FRs capability, the user (in other words, the terminal device) may measure positioning signals for different FRs simultaneously, thereby reducing the positioning measurement time and avoiding excessive extension of the measurement time.

In the embodiments of the present disclosure, the rule for applying the MG pattern #24/25, such as whether the MG pattern #24/25 is allowed to be configured as the per FR type, a use of the MG pattern #24/25 in a concurrent gap, is updated in combination with the per FR PRS gap capability and/or the new user capability.

The exemplary embodiments of the present disclosure are described in detail above with reference to the drawings, but the present disclosure is not limited to the specific details in the above embodiments. Within the technical concept of the present disclosure, a variety of simple variations may be made to the technical solution of the present disclosure, and these simple variations all fall within the protection scope of the present disclosure. For example, various technical features described in the above embodiments may be combined in any suitable manner without contradiction. In order to avoid unnecessary repetition, various possible combinations are not described additionally in the present disclosure. For another example, any combination between different implementations of the present disclosure is also possible, and as long as it does not violate the concept of the present disclosure, which should also be regarded as the contents disclosed in the present disclosure. For another example, under the premise of no conflict, the various embodiments and/or the technical features in the various embodiments described in the present disclosure may be arbitrarily combined with the related art, and the technical solution obtained after the combination should also fall within the protection scope of the present disclosure.

It can also be understood that in the various method embodiments of the present disclosure, a magnitude of a serial number of each of the above-mentioned processes does not imply a sequential order of execution, and the order of execution of the processes should be determined by their function and inherent logic without constituting any limitation of the process of implementing the embodiments of the present disclosure. In addition, in the embodiments of the present disclosure, the terms “downlink”, “uplink” and “sidelink” are each used to indicate a transmission direction of a signal or data, where “downlink” is used to indicate that the transmission direction of the signal or data is a first direction from a site to a user device of a cell, “uplink” is used to indicate that the transmission direction of the signal or data is a second direction from a user device of a cell to a site, and “sidelink” is used to indicate that the transmission direction of the signal or data is a third direction from user device 1 to user device 2. For example, “downlink signal” indicates that the transmission direction of the signal is the first direction. In addition, in the embodiments of the present disclosure, the term “and/or” is only a description of an association relationship of associated objects, which indicates that there may be three kinds of relationships.

For example, “A and/or B” may indicate three situations: A exists alone, both A and B exist, and B exists alone. Moreover, the character “/” herein generally indicates that the associated objects before and after the character “/” are in an “or” relationship

FIG. 6 is a schematic diagram of structural composition of a communication apparatus provided in embodiments of the present disclosure. As shown in FIG. 6, the communication apparatus 600 includes:

a determining unit 601, configured to determine total positioning measurement time according to a maximum value among one or more periods of first positioning measurement time, where the one or more periods of first positioning measurement time correspond to one or more frequency ranges (FRs).

Optionally, the communication apparatus 600 further includes: a communication unit 602, configured to receive a configuration that one or more first FR gaps are used for PRS measurement.

Optionally, the determining unit 601 may determine the total positioning measurement time according to the maximum value among the one or more periods of first positioning measurement time in response to receiving a configuration that one or more first FR gaps are used for PRS measurement, the one or more periods of first positioning measurement time corresponding to the one or more frequency ranges (FRs).

Optionally, the determining unit 601 is further configured to: determine the total positioning measurement time according to first time and the maximum value among the one or more periods of first positioning measurement time.

Optionally, first positioning measurement time corresponding to each FR is determined according to measurement time in each FR and second time corresponding to each FR.

Optionally, the determining unit 601 is further configured to: determine the total positioning measurement time according to a sum of the first time and the maximum value among the one or more periods of first positioning measurement time.

Optionally, the first positioning measurement time corresponding to each FR is determined according to the sum of the measurement time in each FR and the second time corresponding to each FR.

Optionally, the determining unit 601 is further configured to:
determine the total positioning measurement time according to the maximum value among the one or more periods of first positioning measurement time in a case where an independent gap configuration positioning reference signal (PRS) capability is supported and one or more first FR gaps are configured for PRS measurement;
determine the total positioning measurement time according to the maximum value among the one or more periods of first positioning measurement time in a case where a simultaneous processing of PRS for different FRs capability is supported and the one or more first FR gaps for PRS measurement are configured; or
determine the total positioning measurement time according to the maximum value among the one or more periods of first positioning measurement time in a case where the independent gap configuration PRS capability is supported, the simultaneous processing of PRS for different FRs capability is supported, and the one or more first FR gaps for PRS measurement are configured.

Optionally, the determining unit 601 is further configured to: determine the total positioning measurement time according to the maximum value among the one or more periods of first positioning measurement time in a case where the simultaneous processing of PRS for different FRs capability is not supported, and/or the independent gap configuration PRS capability is not supported, and/or the one or more first FR gaps are not configured for PRS measurement.

Optionally, the support for the independent gap configuration PRS capability is independent of the support for the simultaneous processing of PRS for different FRs capability; or

the support for the independent gap configuration PRS capability is a basis for the support for the simultaneous processing of PRS for different FRs capability.

Optionally, each period of first positioning measurement time is determined according to a sum of at least one second positioning measurement time, where the at least one second positioning measurement time is positioning measurement time of at least one positioning frequency layer in a FR corresponding to each period of first positioning measurement time.

Optionally, the communication unit 602 is further configured to:
receive first information in a case where the independent gap configuration PRS capability is supported or in a case where the independent gap configuration PRS capability and a first capability are supported; or
receive second information in a case where the independent gap configuration PRS capability and a second capability are supported or in a case where the independent gap configuration PRS capability, the first capability and the second capability are supported.

The first capability indicates that the terminal device allows or supports configuring a first gap pattern as a per FR type, or the first capability indicates that the terminal device allows or supports the first gap pattern as the per FR type configured in the corresponding FR. The first gap pattern indicates a first measurement gap length (MGL) and a first measurement gap repetition period (MGRP).

The second capability indicates that the terminal device allows or supports configuring one or more first FR gaps in multiple concurrent gaps as the first gap pattern.

The first information indicates to configure the first gap pattern as the per FR type, or the first information indicates the first gap pattern as the per FR type configured in the corresponding FR.

The second information indicates to configure the one or more first FR gaps in the multiple concurrent gaps as the first gap pattern.

Optionally, the first gap pattern includes a measurement gap (MG) pattern 24 and/or MG pattern 25.

Optionally, a reporting manner of the first capability and/or the second capability is the same as a reporting manner of the independent gap configuration PRS capability.

Optionally, the first capability and the second capability are reported via first signaling; or the first capability is reported via first signaling, and the second capability is reported via second signaling.

Optionally, the one or more FRs include a first FR and a second FR; and
the total positioning measurement time T_{Y,Total} is determined according to max(T_{Y,FR1}, T_{Y,FR2});
where T_{Y,FR1} is measurement time of measuring Y in the first FR, or measurement time of measuring Y in a first FR MG, or measurement time of measuring Y in a first FR PPW;
T_{Y,FR2} is measurement time of measuring Y in a second FR, or measurement time of measuring Y in a second FR MG, or measurement time of measuring Y in a second FR PPW; and
Y includes at least one of: PRS reference signal time difference (RSTD), reference signal received power (RSRP) for PRS, reference signal received path power (RSRPP) for PRS, or Rx-Tx time difference.

Optionally, the one or more FRs include a first FR and a second FR; and
the total positioning measurement time T_{Y,Total} is determined according to max(T_{Y,FR1}, T_{Y,FR2})+T_{guard},
where TYFR1 is measurement time of measuring Y in the first FR, or measurement time of measuring Y in a first FR MG, or measurement time of measuring Y in a first FR PPW;
T_{Y,FR2} is measurement time of measuring Y in the second FR, or measurement time of measuring Y in a second FR MG, or measurement time of measuring Y in a second FR PPW;
T_{guard} is first time, and T_{guard} is a maximum T_{effect} among all positioning frequency layers, T_{effect} being a period of Y measurement for each positioning frequency layer; and
Y includes at least one of: PRS RSTD, RSRP for PRS, reference signal received path power (RSRPP) for PRS, or Rx-Tx time difference.

Optionally, the one or more FRs include a first FR and a second FR; and
the total positioning measurement time T_{Y,Total} is determined according to max(T_{Y,FR1}+T_{guard,FR1}, T_{Y,FR2}+T_{guard,FR2});
where T_{Y,FR1} is measurement time of measuring Y in the first FR, or measurement time of measuring Y in a first FR MG, or measurement time of measuring Y in a first FR PPW;
T_{Y,FR2} is measurement time of measuring Y in the second FR, or measurement time of measuring Y in a second FR MG, or measurement time of measuring Y in a second FR PPW;
T_{guard,FR1} is second time corresponding to the first FR, and T_{guard,FR1} is a maximum T_{effect} among all positioning frequency layers in the first FR, T_{effect} being a period of Y measurement for each positioning frequency layer;
T_{guard,FR2} is second time corresponding to the second FR, and T_{guard,FR2} is a maximum T_{effect} among all positioning frequency layers in the second FR; and
Y includes at least one of: PRS RSTD, RSRP for PRS, reference signal received path power (RSRPP) for PRS, or Rx-Tx time difference.

Optionally, T_{Y,FR1} and T_{Y,FR2} are determined according to formulas as follows:

$$\begin{matrix}{T}_{Y , F R 1} = {\sum }_{i = 1}^{L\_FR 1} {T}_{Y , i , FR 1} + ( L\_FR1 - 1 ) * max ( {T}_{effect , i} ) ; and \\ {T}_{Y , FR 2} = {\sum }_{i = 1}^{L\_FR 2} {T}_{Y , i , FR 2} + ( L\_FR2 - 1 ) * max ( {T}_{effect , i} ) ;\end{matrix}$$

where i is an index of a positioning frequency layer;
L_FR1 is a total number of positioning frequency layers of the first FR;
L_FR2 is a total number of positioning frequency layers of the second FR; and
T_{effect,i} is a period of Y measurement in a positioning frequency layer i.

Optionally, the determining unit 601 is further configured to determine the total positioning measurement time according to third positioning measurement time corresponding to a PRS processing window (PPW) and a maximum value among one or more periods of first positioning measurement time corresponding to one or more FR MGs.

Optionally, the third positioning measurement time corresponding to the PPW includes:
a maximum value of at least one positioning measurement time corresponding to at least one FR PPW; or
a sum of the at least one positioning measurement time corresponding to the at least one FR PPW.

Optionally, the determining unit 601 is further configured to determine the total positioning measurement time according to the third positioning measurement time, first time and the maximum value among the one or more periods of first positioning measurement time corresponding to the one or more FR MGs.

The determining unit 601 is further configured to: determine the total positioning measurement time according to a sum of the third positioning measurement time and the maximum value among the one or more periods of first positioning measurement time corresponding to the one or more FR MGs; or

the determining unit 601 is further configured to determine the total positioning measurement time according to a sum of the third positioning measurement time, the first time, and the maximum value among the one or more periods of first positioning measurement time corresponding to the one or more FR MGs.

Optionally, the first positioning measurement time and/or the total positioning measurement time and/or the second positioning measurement time and/or the third positioning measurement time includes at least one of:
measurement time of PRS reference signal time difference (RSTD) measurement;
reference signal received power (RSRP) for PRS;
measurement time of reference signal received path power (RSRPP) for PRS measurement;
measurement time of Rx-Tx time difference measurement; or
measurement time for PRS phase measurement.

Optionally, the one or more FRs include a first FR and a second FR; and the total positioning measurement time T_{Y,Total} is determined according to one of:

$$\begin{matrix}max ( {T}_{Y , FR 1 , MG} , {T}_{Y , FR 2 , MG} ) + {T}_{Y , PPW} ; \\ max ( {T}_{Y , FR 1 , MG} , {T}_{Y , FR 2 , MG} ) + {T}_{Y , PPW} + {T}_{guard} ; \\ max ( {T}_{Y , FR 1 , MG} , {T}_{Y , FR 2 , MG} ) + max ( {T}_{Y , FR 1 , PPW} , {T}_{Y , FR 2 , PPW} ) ; \\ max ( {T}_{Y , FR 1 , MG} , {T}_{Y , FR 2 , MG} ) + max ( {T}_{Y , FR 1 , PPW} , {T}_{Y , FR 2 , PPW} ) + {T}_{guard} ; \\ max ( {T}_{Y , FR 1 , MG} , {T}_{Y , FR 2 , MG} ) + {T}_{Y , FR 1 , PPW} + {T}_{Y , FR 2 , PPW} ; and \\ max ( {T}_{Y , FR 1 , MG} , {T}_{Y , FR 2 , MG} ) + {T}_{Y , FR 1 , PPW} + {T}_{Y , FR 2 , PPW} + {T}_{guard} ;\end{matrix}$$

where T_{Y,FR1}, MG is measurement time of measuring Y in a first FR MG;
T_{Y,FR2}, MG is measurement time of measuring Y in a second FR MG;
T_{Y,PPW} is measurement time of measuring Y within a PPW;
T_{guard} is first time, and T_{guard} is a maximum T_{effect} among all positioning frequency layers, T_{effect} being a period of Y measurement for each positioning frequency layer;
T_{Y,FR1,PPW} is measurement time for measuring Y in a first FR PPW;
T_{Y,FR2,PPW} is measurement time of measuring Y in a second FR PPW; and
Y includes at least one of: PRS RSTD, RSRP for PRS, reference signal received path power (RSRPP) for PRS, or Rx-Tx time difference.

Optionally, first positioning measurement time corresponding to each FR is determined according to measurement time of measuring Y in each FR MG and/or measurement time of measuring Y in each FR PPW; or
the first positioning measurement time corresponding to each FR is determined according to the measurement time of measuring Y in each FR MG and/or the measurement time of measuring Y in each FR PPW and according to the first time or second time corresponding to each FR;
where Y includes at least one of: PRS RSTD, RSRP for PRS, reference signal received path power (RSRPP) for PRS, or Rx-Tx time difference.

Optionally, first positioning measurement time corresponding to each FR is determined according to a sum of measurement time of measuring Y in each FR MG and measurement time of measuring Y in each FR PPW; or
the first positioning measurement time corresponding to each FR is determined according to the sum of the measurement time of measuring Y in each FR MG, the measurement time of measuring Y in each FR PPW, and first time or second time corresponding to each FR;
where Y includes at least one of: PRS RSTD, RSRP for PRS, reference signal received path power (RSRPP) for PRS, or Rx-Tx time difference.

Optionally, the one or more FRs include a first FR and a second FR; and
first positioning measurement time T_{Y,FR1} corresponding to the first FR is determined according to one of:

$$\begin{matrix}{T}_{Y , FR 1 , MG} + {T}_{Y , FR 1 , PPW} ; \\ {T}_{Y , FR 1 , MG} + {T}_{Y , FR 1 , PPW} + {T}_{guard , FR 1} ; and \\ {T}_{Y , FR 1 , MG} + {T}_{Y , FR 1 , PPW} + {T}_{guard} ;\end{matrix}$$

first positioning measurement time T_{Y,FR2} corresponding to the second FR is determined according to one of:

$$\begin{matrix}{T}_{Y , FR 2 , MG} + {T}_{Y , FR 2 , PPW} ; \\ {T}_{Y , FR 2 , MG} + {T}_{Y , FR 2 , PPW} + {T}_{guard , FR 2} ; and \\ {T}_{Y , FR 2 , MG} + {T}_{Y , FR 2 , PPW} + {T}_{guard} ;\end{matrix}$$

where T_{Y,FR1,MG} is measurement time of measuring Y in a first FR MG; T_{Y,FR2,MG} is measurement time of measuring Y in a second FR MG;
T_{Y,FR1,PPW} is measurement time of measuring Y in a first FR PPW; T_{Y,FR2,PPW} is measurement time of measuring Y in a second FR PPW;
T_{guard,FR1} is second time corresponding to the first FR, and T_{guard,FR1} is a maximum T_{effect} among all positioning frequency layers in the first FR, T_{effect} being a period of Y measurement for each positioning frequency layer; T_{guard,FR2} is second time corresponding to the second FR, and T_{guard,FR2} is a maximum T_{effect} among all positioning frequency layers in the second FR;
T_{guard} is the first time, and T_{guard} is a maximum T_{effect} among all positioning frequency layers; and
Y includes at least one of: PRS RSTD, RSRP for PRS, reference signal received path power (RSRPP) for PRS, or Rx-Tx time difference.

Optionally, T_{Y,FR1,MG} and T_{Y,FR2,MG} are determined according to formulas as follows:

$$\begin{matrix}{T}_{Y , FR 1 , MG} = {\sum }_{i = 1}^{{L\_FR 1}^{′}} {T}_{Y , i , FR 1} + ( {L\_FR1}^{′} - 1 ) * max ( {T}_{effect , i} ) ; and \\ {T}_{Y , FR 2 , MG} = {\sum }_{i = 1}^{L\_FR {2}^{′}} {T}_{Y , i , FR 2} + ( {L\_FR2}^{′} - 1 ) * max ( {T}_{effect , i} ) ;\end{matrix}$$

where i is an index of a positioning frequency layer;
L_FR1′ is a total number of positioning frequency layers for MG-based measurement in the first FR;
L_FR2′ is a total number of positioning frequency layers for MG-based measurement in the second FR; and
T_{effect,i} is a period of Y measurement in a positioning frequency layer i.

Optionally, T_{Y,i,FR1} and T_{Y,i,FR2} are determined according to formulas as follows:

$${T}_{Y , i , FR 1} = ( {k}_{m u l t i T E G , i} * C S S {F}_{P R S , i , FR 1} * ceil ( {K}_{p , P R S , i} ) * {N}_{R x B e a m , i} * ⌈ \frac{{N}_{PRS , i}^{slot}}{{N}^{′}} ⌉ ⌈ \frac{{L}_{available\_PRS , i}}{N} ⌉ * {N}_{s a m p l e} - 1 ) * {T}_{effect , i} + {T}_{last , i} ; and$$

$${T}_{Y , i , FR 2} = ( {k}_{m u l t i T E G , i} * C S S {F}_{P R S , i , FR 2} * ceil ( {K}_{p , P R S , i} ) * {N}_{R x B e a m , i} * ⌈ \frac{{N}_{PRS , i}^{slot}}{{N}^{′}} ⌉ ⌈ \frac{{L}_{available\_PRS , i}}{N} ⌉ * {N}_{s a m p l e} - 1 ) * {T}_{effect , i} + {T}_{last , i} ;$$

where N_{RxBeam,i} is a receive (Rx) beam scanning factor of the terminal device;
CSSF_{PRSi,FR1} is a carrier specific scaling factor of positioning measurement based on a new radio (NR) PRS in a positioning frequency layer i of the first FR, and CSSF_{PRS,i,FR2} is a carrier specific scaling factor of a positioning measurement based on the NR PRS in a positioning frequency layer i of the second FR;
k_{multiTEG,i} is a scaling factor for measuring a same PRS resource having multiple Rx time error groups (TEGs);
K_{p,PRS,i} is a scaling factor of a positioning frequency layer to be measured within an associated measurement gap pattern;

$${N}_{P R S , i}^{slot}$$

is a maximum number of downlink (DL) PRS resources in positioning frequency layer i configured in one slot;
N is duration of a DL PRS symbol, measured in milliseconds (ms);
L_{available_PRS,i} is duration of available PRS in a positioning frequency layer i to be measured during T_{available_PRS,i}; T_{available}_PRS,i=LCM(T_{PRS,i}, T_{DRX}), where LCM(T_{PRS,i}, T_{DRX}) is a least common multiple of T_{PRS,i} and a DRX period TORX, and T_{PRS,i} is a period of silent DL PRS resources on the positioning frequency layer i;
N′ is a capability for which the terminal device is capable of processing a number of DL PRS resources in one slot;
Nₛₐₘₚₗₑ is a number of samples of Y measurement;
T_{effect,i} is a period of Y measurement in the positioning frequency layer i; and
T_{last,i} is measurement duration for a last PRS RSTD sample in the positioning frequency layer i.

Optionally, T_{Y,FR1,PPW} and T_{Y,FR2,PPW} are determined according to formulas as follows:

$${T}_{Y , FR 1 , P P W} = {\sum }_{i = 1}^{{L\_FR 1}^{″}} {T}_{Y\_wo \_gap , i} + ( {L\_FR1}^{″} - 1 ) * max ( {T}_{effect , i} ) ; and$$

$${T}_{Y , F R 2 , P P W} = {\sum }_{i = 1}^{{L\_FR 2}^{″}} {T}_{Y\_wo \_gap , i} + ( {L\_FR2}^{″} - 1 ) * max ( {T}_{effect , i} ) ;$$

where i is an index of a positioning frequency layer;
L_FR1″ is a total number of positioning frequency layers for PPW-based measurement in the first FR;
L_FR2″ is a total number of positioning frequency layers for PPW-based measurement in the second FR; and
T_{effect,i} is a period of Y measurement in a positioning frequency layer i.

Optionally, T_{Y_wo_gap,i} is determined according to the formulas as follows:

$${T}_{Y\_wo \_gap , i} = ( {k}_{m u l t i T E G , i} * {N}_{RxBeam , i} * ⌈ \frac{{N}_{PRS , i}^{slot}}{{N}^{′}} ⌉ ⌈ \frac{{L}_{available\_PRS , i}}{N} ⌉ * {N}_{sample} - 1 ) * {T}_{effect , i} + {T}_{l a s t , i} ;$$

where k_{multiTEG,i} is a scaling factor for measuring a same PRS resource having multiple Rx time error groups (TEGs);
N_{RxBeam,i} is a receive (Rx) beam scanning factor of the terminal device;

$${N}_{P R S , i}^{slot}$$

is a maximum number of downlink (DL) PRS resources in a positioning frequency layer i configured in one slot;
N is duration of a DL PRS symbol, measured in ms;
L_{available_PRS,i} is duration of available PRS in a positioning frequency layer i to be measured during T_{available_PRS,i}; T_{available}_PRS,i=LCM(T_{PRS,i}, T_{DRX}), where LCM(T_{PRS,i}, T_{DRX}) is a least common multiple of T_{PRS,i} and a DRX period T_{DRX}, and T_{PRS,i} is a period of silent DL PRS resources on the positioning frequency layer i;
N′ is a capability for which the terminal device is capable of processing a number of DL PRS resources in one slot;
Nₛₐₘₚₗₑ is a number of samples of Y measurement;
T_{effect,i} is a period of Y measurement in the positioning frequency layer i; and
T_{last,i} is measurement duration for a last Y sample in the positioning frequency layer i.

FIG. 7 is a schematic diagram of structural composition of another communication apparatus provided in embodiments of the present disclosure. As shown in FIG. 7, the communication apparatus 700 includes:

a communication unit 701, configured to: receive first information in a case where an independent gap configuration positioning reference signal (PRS) capability is supported or in a case where the independent gap configuration PRS capability and a first capability are supported; or receive second information in a case where the independent gap configuration PRS capability and a second capability are supported or in a case where the independent gap configuration PRS capability, the first capability and the second capability are supported.

The first capability indicates that a terminal device allows or supports configuring a first gap pattern as a per FR type, or the first capability indicates that the terminal device allows or supports the first gap pattern as a per FR type configured in a corresponding FR. The first gap pattern indicates a first measurement gap length (MGL) and a first measurement gap repetition period (MGRP).

The second capability indicates that the terminal device allows or supports configuring one or more first FR gaps in multiple concurrent gaps as the first gap pattern.

The first information indicates to configure the first gap pattern as the per FR type, or the first information indicates the first gap pattern as the per FR type configured in the corresponding FR.

The second information indicates to configure the one or more first FR gaps in the multiple concurrent gaps as the first gap pattern.

Optionally, for the allowing or supporting, when a subject is not reflected, the communication apparatus 700 may realize the allowing or supporting, or a terminal device applied to the communication apparatus 700 may realize the allowing or supporting.

Optionally, a reporting manner of the first capability and/or the second capability is the same as a reporting manner of the independent gap configuration PRS capability.

Optionally, the communication apparatus 700 further includes: a determining unit 702 configured to determine a supported capability.

Optionally, the first gap pattern includes MG pattern 24 and/or MG pattern 25. Optionally, the first capability and the second capability are reported via first signaling. Alternatively, the first capability is reported via first signaling and the second capability is reported via second signaling.

Optionally, the determining unit 702 is further configured to determine the total positioning measurement time according to a maximum value among one or more periods of first positioning measurement time, the one or more periods of first positioning measurement time corresponding to one or more frequency ranges (FRs).

Optionally, the determining unit 702 is further configured to determine the total positioning measurement time according to first time and the maximum value among the one or more periods of first positioning measurement time.

Optionally, first positioning measurement time corresponding to each FR is determined according to measurement time in each FR and second time corresponding to each FR.

Optionally, the determining unit 702 is further configured to:
determine the total positioning measurement time according to the maximum value among the one or more periods of first positioning measurement time in a case where an independent gap configuration positioning reference signal PRS capability is supported and one or more first FR gaps are configured for PRS measurement;
determine the total positioning measurement time according to the maximum value among the one or more periods of first positioning measurement time in a case where a simultaneous processing of PRS for different FRs capability is supported and the one or more first FR gaps for PRS measurement are configured; or
determine the total positioning measurement time according to the maximum value among the one or more periods of first positioning measurement time in a case where the independent gap configuration PRS capability is supported, the simultaneous processing of PRS for different FRs capability is supported and the one or more first FR gaps for PRS measurement are configured.

Optionally, the determining unit 702 is further configured to determine the total positioning measurement time according to third positioning measurement time corresponding to a PRS processing window (PPW) and a maximum value among one or more periods of first positioning measurement time corresponding to one or more FR MGs.

Optionally, the first positioning measurement time and/or the total positioning measurement time and/or the second positioning measurement time and/or the third positioning measurement time includes at least one of:
measurement time of PRS reference signal time difference (RSTD) measurement;
reference signal received power (RSRP) for PRS;
measurement time of reference signal received path power (RSRPP) for PRS measurement;
measurement time of Rx-Tx time difference measurement; or
measurement time for PRS phase measurement.

Optionally, first positioning measurement time corresponding to each FR is determined according to measurement time of measuring Y in each FR MG and/or measurement time of measuring Y in each FR PPW; or
the first positioning measurement time corresponding to each FR is determined according to the measurement time of measuring Y in each FR MG and/or the measurement time of measuring Y in each FR PPW and according to the first time or second time corresponding to each FR;
where Y includes at least one of: PRS RSTD, RSRP for PRS, reference signal received path power (RSRPP) for PRS, or Rx-Tx time difference.

FIG. 8 is a schematic diagram of structural composition of yet another communication apparatus provided in embodiments of the present disclosure. As shown in FIG. 8, the communication apparatus 800 includes:

a communication unit 801, configured to configure one or more first frequency range (FR) gaps to a terminal device for positioning reference signal (PRS) measurement, where the one or more first FR gaps are used for PRS measurement and for the terminal device to determine total positioning measurement time according to a maximum value among one or more periods of first positioning measurement time, the one or more periods of first positioning measurement time corresponding to one or more FRs.

Optionally, the communication apparatus 800 further includes: a determining unit 802 configured to determine the one or more first FR gaps for PRS measurement.

Optionally, the communication unit 801 is further configured to: configure the one or more first FR gaps to the terminal device for PRS measurement in response to receiving support for an independent gap configuration positioning reference signal (PRS) capability transmitted by the terminal device, or in response to receiving support for a simultaneous processing of PRS for different FRs capability transmitted by the terminal device, or in response to receiving the support for the independent gap configuration PRS capability and the support for the simultaneous processing of PRS for different FRs capability transmitted by the terminal device.

Optionally, the communication unit 801 is further configured to:

configure first information to the terminal device in response to receiving the support for the independent gap configuration PRS capability transmitted by the terminal device or in response to receiving support for the independent gap configuration PRS capability and a first capability transmitted by the terminal device; or configure second information to the terminal device in response to receiving support for the independent gap configuration PRS capability and a second capability transmitted by the terminal device or in response to receiving support for the independent gap configuration PRS capability, the first capability and the second capability transmitted by the terminal device.

The first capability indicates that the terminal device allows or supports configuring a first gap pattern as a per FR type, or the first capability indicates that the terminal device allows or supports the first gap pattern as a per FR type configured in a corresponding FR. The first gap pattern indicates a first measurement gap length (MGL) and a first measurement gap repetition period (MGRP).

The second capability indicates that the terminal device allows or supports configuring one or more first FR gaps in multiple concurrent gaps as the first gap pattern.

The first information indicates to configure the first gap pattern as the per FR type, or the first information indicates the first gap pattern as the per FR type configured in the corresponding FR.

The second information indicates to configure the one or more first FR gaps in the multiple concurrent gaps as the first gap pattern.

Optionally, the first gap pattern includes MG pattern 24 and/or MG pattern 25.

FIG. 9 is a schematic diagram of structural composition of yet another communication apparatus provided in embodiments of the present disclosure. As shown in FIG. 9, the communication apparatus 900 includes: a communication unit 901 configured to:

configure first information to a terminal device in response to receiving support for an independent gap configuration positioning reference signal (PRS) capability transmitted by the terminal device, or in response to receiving support for the independent gap configuration PRS capability and a first capability transmitted by the terminal device; or configure second information to the terminal device in response to receiving support for the independent gap configuration PRS capability and a second capability transmitted by the terminal device, or in response to receiving support for the independent gap configuration PRS capability, the first capability and the second capability transmitted by the terminal device.

The first capability indicates that the terminal device allows or supports configuring a first gap pattern as a per FR type, or the first capability indicates that the terminal device allows or supports the first gap pattern as a per FR type configured in a corresponding FR. The first gap pattern indicates a first measurement gap length (MGL) and a first measurement gap repetition period (MGRP).

The second capability indicates that the terminal device allows or supports configuring one or more first FR gaps in multiple concurrent gaps as the first gap pattern.

The first information indicates to configure the first gap pattern as the per FR type, or the first information indicates the first gap pattern as the per FR type configured in the corresponding FR.

The second information indicates to configure the one or more first FR gaps in the multiple concurrent gaps as the first gap pattern.

Optionally, the communication apparatus 900 further includes: a determining unit 902 configured to determine the first information or the second information.

Optionally, the first gap pattern includes MG pattern 24 and/or MG pattern 25.

Optionally, the communication unit 901 is further configured to: configure the one or more first FR gaps to the terminal device for PRS measurement, where the first FR gap is used for PRS measurement and for the terminal device to determine total positioning measurement time according to a maximum value among one or more periods of first positioning measurement time, the one or more periods of first positioning measurement time corresponding to one or more frequency ranges (FRs).

Optionally, the communication unit 901 is further configured to: configure the one or more first FR gaps to the terminal device for PRS measurement in response to receiving the support for the independent gap configuration PRS capability transmitted by the terminal device, in response to receiving support for a simultaneous processing of PRS for different FRs capability transmitted by the terminal device, or in response to receiving the support for the independent gap configuration PRS capability and the support for the simultaneous processing of PRS for different FRs capability transmitted by the terminal device.

Those skilled in the art should understand that the related descriptions of the above-mentioned communication apparatuses in the embodiments of the present disclosure can be understood with reference to the related descriptions of the communication methods in the embodiments of the present disclosure. Optionally, the communication apparatus 600 and/or the communication apparatus 700 may include a terminal device, or may be applied to a terminal device, or may be a part of a terminal device. Optionally, the communication apparatus 800 and/or the communication apparatus 900 may include a network device, or may be applied to a network device, or may be a part of a network device.

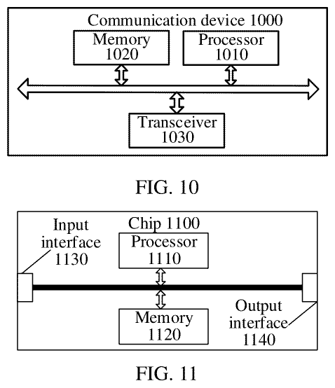

FIG. 10 is a schematic structural diagram of a communication device provided in embodiments of the present disclosure. The communication device 1000 may include one of: a terminal device or a network device. The communication device 1000 shown in FIG. 10 may include a processor 1010 and a memory 1020. The memory 1020 is configured to store a computer program. The processor 1010 is configured to call and run the computer program stored in the memory 1020, to cause the communication device 1000 to perform the method according to any of the above embodiments. Optionally, the processor 1010 is configured to call and run the computer program stored in the memory 1020, to cause the terminal device to perform the method according to any of the above embodiments. Optionally, the processor 1010 is configured to call and run the computer program stored in the memory 1020, to cause the network device to perform the method according to any of the above embodiments.

Optionally, the memory 1020 may be a separate device independent of the processor 1010, or may be integrated into the processor 1010.

In some embodiments, as shown in FIG. 10, the communication device 1000 may further include a transceiver 1030. The processor 1010 may control the transceiver 1030 to communicate with other devices. For example, the processor 1010 may control the transceiver 1030 to transmit information or data to other devices, or receive information or data transmitted by other devices.

The transceiver 1030 may include a transmitter and a receiver. The transceiver 1030 may further include antenna(s), and there may be one or more antennas.

In some embodiments, the communication device 1000 may be the network device in the embodiments of the present disclosure, and the communication device 1000 may implement corresponding processes implemented by the network device in all methods of the embodiments of the present disclosure, which will not be repeated here for brevity.

In some embodiments, the communication device 1000 may be the terminal device in the embodiments of the present disclosure, and the communication device 1000 may implement corresponding processes implemented by the terminal device in all methods of the embodiments of the present disclosure, which will not be repeated here for brevity.

The embodiments of the present disclosure further provide a non-transitory computer storage medium. The non-transitory computer storage medium stores one or more programs, and the one or more programs are executable by one or more processors, to implement the communication method according to any one of embodiments of the present disclosure.

In some embodiments, the non-transitory computer-readable storage medium is capable of being applied to the terminal device or the network device in the embodiments of the present disclosure, and the computer program(s) cause a computer to execute corresponding processes implemented by the terminal device or the network device in all methods of the embodiments of the present disclosure, which will not be repeated here for brevity.

FIG. 11 is a schematic structural diagram of a chip according to embodiments of the present disclosure. The chip 1100 shown in FIG. 11 includes a processor 1110, and the processor 1110 is configured to call and run a computer program from a memory, to implement the method in any one of the embodiments of the present disclosure.

In some embodiments, as shown in FIG. 11, the chip 1100 may further include a memory 1120. The processor 1110 may call and run a computer program from the memory 1120, to implement the methods in the embodiments of the present disclosure.

The memory 1120 may be a separate device independent of the processor 1110, or the memory 1120 may be integrated into the processor 1110.

In some embodiments, the chip 1100 may further include an input interface 1130. The processor 1110 may control the input interface 1130 to communicate with other devices or chips. For example, the processor 1110 may control the input interface 1130 to obtain information or data transmitted by other devices or chips.

In some embodiments, the chip 1100 may further include an output interface 1140. The processor 1110 may control the output interface 1140 to communicate with other devices or chips. For example, the processor 1110 may control the output interface 1140 to output information or data to other devices or chips.

In some embodiments, the chip may be applied to the network device in the embodiments of the present disclosure, and the chip may implement corresponding processes implemented by the network device in all methods in the embodiments of the present disclosure, which will not be repeated here for brevity.

In some embodiments, the chip may be applied to the terminal device in the embodiments of the present disclosure, and the chip may implement corresponding processes implemented by the terminal device in all methods in the embodiments of the present disclosure, which will not be repeated here for brevity.

It should be understood that the chip in the embodiments of the present disclosure may also be referred to as a system on a chip, a system chip, a chip system or a system-on-chip.

The embodiments of the present disclosure further provide a computer program product. The computer program product includes a non-transitory computer storage medium, the non-transitory computer storage medium stores a computer program, and the computer program includes instructions executable by at least one processor. When the instructions are executed by the at least one processor, the communication method in any one of the embodiments of the present disclosure is implemented.

In some embodiments, the computer program product can be applied to the terminal device or the network device in the embodiments of the present disclosure, and the computer program instructions cause a computer to execute corresponding processes implemented by the terminal device or the network device in all methods of the embodiments of the present disclosure, which will not be repeated for brevity.

Optionally, the computer program product in the embodiments of the present disclosure may also be referred to as a software product in other embodiments.

The embodiments of the present disclosure further provide a computer program that causes a computer to execute the communication method according to any one of the embodiments of the present disclosure.

In some embodiments, the computer program can be applied to the terminal device or the network device in the embodiments of the present disclosure, and the computer program which, when run on the computer, causes the computer to execute the corresponding process implemented by the terminal device or the network device in all methods of the embodiments of the present disclosure, which will not be repeated here for brevity.

In the embodiments of the present disclosure, the processor, the communication apparatus or the chip may be an integrated circuit chip and have a capability of processing signals. In an implementation process, all steps in the above method embodiments may be completed by an integrated logic circuit of hardware in a processor or instructions in a software form. The processor, the communication apparatus or the chip mentioned above may include a integration of one or more of: a general-purpose processor, an application specific integrated circuit (ASIC), a digital signal processor (DSP), a digital signal processing device (DSPD), a programmable logic device (PLD), a field programmable gate array (FPGA), a central processing unit (CPU), a graphics processing unit (GPU), a neural-network processing unit (NPU), a controller, a microcontroller, a microprocessor, a programmable logic apparatus, a discrete gate or transistor logic device, or a discrete hardware component. All methods, steps and logical block diagrams disclosed in the embodiments of the present disclosure can be implement or performed. The general-purpose processor may be a microprocessor, or the processor may be any conventional processor. The steps of the method disclosed in combination with the embodiments of the present disclosure may be directly embodied as being performed and implemented by a hardware decoding processor, or by using a combination of hardware and software modules in the decoding processor. The software module may be located in a mature storage medium in the art such as a random memory, a flash memory, a read-only memory, a programmable read-only memory or an electrically erasable programmable memory, or a register. The storage medium is located in the memory, and the processor reads information in the memory and implements the steps of the above methods in combination with hardware of the processor.

It can be understood that, the memory or the non-transitory computer storage medium in the embodiments of the present disclosure may be a volatile memory or a non-volatile memory, or may include both volatile and the non-volatile memories. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a random access memory (RAM), which is used as an external cache. Through illustrative, rather than limiting, illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM). It should be noted that the memories of the system and the method described herein are intended to include, but not limited to, these and any other suitable types of memories.

It should be understood that the above memories or the non-transitory computer storage mediums are exemplary but are not limiting illustrations. For example, the memory in embodiments of the present disclosure may also be a static random access memory (static RAM, SRAM), a dynamic random access memory (dynamic RAM, DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM), etc. That is, the memory in the embodiments of the present application is intended to include, but not limited to, these memories and any other suitable types of memories.

Those ordinary skilled in the art will realize that units and algorithm steps of the examples described in combination with the embodiments disclosed herein can be implemented in electronic hardware or in a combination of computer software and electronic hardware. Whether these functions are performed by way of hardware or software depends on an application and a design constraint of the technical solution. A skilled person may use different methods for each application, to implement the described functions, but such implementation should not be considered beyond the scope of the present application.

Those skilled in the art will clearly understand that, for convenience and brevity of the description, as for the working processes of the above-described system, apparatus and e unit reference may be made to the corresponding processes in the above method embodiments, and details will not be repeated here.

In several embodiments provided in the present application, it will be understood that, the disclosed systems, apparatuses/devices, and methods may be implemented through other manners. For example, the apparatus embodiments described above are merely exemplary. For example, the division of the units is only a logical functional division. In an actual implementation, there may be other division manners. For example, a plurality of units or components may be combined or integrated into another system, or some features may be ignored or not executed. In addition, the mutual coupling or direct coupling or communicative connection shown or discussed may be an indirect coupling or communicative connection through some interfaces, apparatuses or units, and may be an electrical connection, a mechanical connection, or other forms of connections.

The units illustrated as separate components may be or may not be physically separated, and the components shown as units may be or may not be physical units. That is, they may be located in one place, or may be distributed onto a plurality of network units. Some or all of the units may be selected according to actual needs, to achieve the purposes of the solutions in the embodiments.

In addition, the functional units in the embodiments of the present application may be integrated into a single processing unit, or the units may be separate physical units, or two or more units may be integrated into a single unit.

In any one of the embodiments of the present disclosure, a time interval, a time period, being within a time range, being within a time period, being within a time window or the like may include all of endpoint time, may include some of the endpoint time (for example, including a left endpoint time but not including a right endpoint time, or including the right endpoint time but not including the left endpoint time), or may not include the endpoint time.

If the described functions are implemented in the form of a software functional unit and sold or used as an independent product, they may be stored in a non-transitory computer-readable storage medium. Based on this understanding, the technical solutions of the present application, in essence, or part of the technical solutions that contributes to the related art, or part of the technical solutions, may be embodied in the form of a software product. The computer software product is stored in a storage medium, and includes several instructions to cause a computer device (which may be a personal computer, a server, or a network device, etc.) to perform all or part of the steps of the methods described in the various embodiments of the present application. The storage medium mentioned above includes various types of medium capable of storing program codes, such as a USB flash drive (U disk), a mobile hard disk, a read-only memory (ROM), a random access memory (RAM), a diskette, or an optical disk.

The foregoing descriptions are merely exemplary implementations of the present application, but the protection scope of the present application is not limited thereto. Any skilled person in the art could readily conceive of variations or replacements within the technical scope disclosed in the present application, which shall be all included in the protection scope of the present application. Therefore, the protection scope of the present application shall be subject to the protection scope of the claims

What is claimed is:

1. A terminal device, comprising a processor and a memory, wherein the memory is configured to store a computer program; and
the processor is configured to call and run the computer program stored in the memory, to cause the terminal device to perform:
determining total positioning measurement time according to a maximum value among one or more periods of first positioning measurement time, wherein the one or more periods of first positioning measurement time correspond to one or more frequency ranges (FRs).

2. The terminal device according to claim 1, wherein the processor is configured to call and run the computer program stored in the memory, to cause the terminal device to perform:
determining the total positioning measurement time according to first time and the maximum value among the one or more periods of first positioning measurement time;
or
wherein first positioning measurement time corresponding to each FR is determined according to measurement time in each FR and second time corresponding to each FR.

3. The terminal device according to claim 2, wherein the processor is configured to call and run the computer program stored in the memory, to cause the terminal device to perform:
determining the total positioning measurement time according to a sum of the first time and the maximum value among the one or more periods of first positioning measurement time;
or
wherein the first positioning measurement time corresponding to each FR is determined according to a sum of the measurement time in each FR and the second time corresponding to each FR.

4. The terminal device according to claim 1, wherein the processor is configured to call and run the computer program stored in the memory, to cause the terminal device to perform:
in a case where the terminal device supports an independent gap configuration positioning reference signal (PRS) capability and the terminal device is configured with one or more first FR gaps for PRS measurement, determining the total positioning measurement time according to the maximum value among the one or more periods of first positioning measurement time;
in a case where the terminal device supports a simultaneous processing of PRS for different FRs capability and the terminal device is configured with the one or more first FR gaps for PRS measurement, determining the total positioning measurement time according to the maximum value among the one or more periods of first positioning measurement time; or
in a case where the terminal device supports the independent gap configuration PRS capability and the simultaneous processing of PRS for different FRs capability and the terminal device is configured with the one or more first FR gaps for PRS measurement, determining the total positioning measurement time according to the maximum value among the one or more periods of first positioning measurement time.

5. The terminal device according to claim 1, wherein the terminal device further performs:
in a case where the terminal device does not support a simultaneous processing of PRS for different FRs capability and/or the terminal device does not support an independent gap configuration PRS capability and/or the terminal device is not configured with one or more first FR gaps for PRS measurement, determining the total positioning measurement time according to a sum of the one or more periods of first positioning measurement time.

6. The terminal device according to claim 4, wherein the terminal device supporting the independent gap configuration PRS capability is independent of the terminal device supporting the simultaneous processing of PRS for different FRs capability; or the terminal device supporting the independent gap configuration PRS capability is a basis for the terminal device supporting the simultaneous processing of PRS for different FRs capability.

7. The terminal device according to claim 1, wherein each period of first positioning measurement time is determined according to a sum of at least one second positioning measurement time, and the at least one second positioning measurement time is positioning measurement time of at least one positioning frequency layer in a FR corresponding to each period of first positioning measurement time.

8. The terminal device according to claim 1, wherein the terminal device further performs:
receiving first information in a case where the terminal device supports an independent gap configuration PRS capability or in a case where the terminal device supports the independent gap configuration PRS capability and a first capability; or
receiving second information in a case where the terminal device supports the independent gap configuration PRS capability and a second capability or in a case where the terminal device supports the independent gap configuration PRS capability, the first capability and the second capability; wherein
the first capability indicates that the terminal device allows or supports configuring a first gap pattern as a per FR type, or the first capability indicates that the terminal device allows or supports a first gap pattern as a per FR type configured in a corresponding FR; the first gap pattern indicates a first measurement gap length (MGL) and a first measurement gap repetition period (MGRP);
the second capability indicates that the terminal device allows or supports configuring one or more first FR gaps in multiple concurrent gaps as the first gap pattern;
the first information indicates to configure the first gap pattern as the per FR type, or the first information indicates the first gap pattern as the per FR type configured in the corresponding FR; and
the second information indicates to configure the one or more first FR gaps in the multiple concurrent gaps as the first gap pattern.

9. The terminal device according to claim 8, wherein a reporting manner of the first capability and/or the second capability is the same as a reporting manner of the independent gap configuration PRS capability.

10. The terminal device according to claim 8, wherein the first capability and the second capability are reported via first signaling; or the first capability is reported via first signaling and the second capability is reported via second signaling.

11. The terminal device according to claim 1, wherein the one or more FRs comprise a first FR and a second FR;
the total positioning measurement time T_{Y,Total} is determined according to max(T_{Y,FR1}, T_{Y,FR2}); or
the total positioning measurement time T_{Y,Total} is determined according to max(T_{Y,FR1}, T_{Y,FR2})+T_{guard}; or
the total positioning measurement time T_{Y,Total} is determined according to max(T_{Y,FR1}+T_{guard,FR1}, T_{Y,FR2}+T_{guard,FR2}); wherein
T_{Y,FR1} is measurement time of measuring Y in the first FR, or measurement time of measuring Y in a first FR MG, or measurement time of measuring Y in a first FR PPW; T_{Y,FR2} is measurement time of measuring Y in the second FR, or measurement time of measuring Y in a second FR MG, or measurement time of measuring Y in a second FR PPW; wherein Y comprises at least one of: PRS reference signal time difference (RSTD), reference signal received power (RSRP) for PRS, reference signal received path power (RSRPP) for PRS, or Rx-Tx time difference;
T_{guard} is the first time, and T_{guard} is a maximum T_{effect} among all positioning frequency layers, T_{effect} being a period of Y measurement for each positioning frequency layer; and
T_{guard,FR1} is second time corresponding to the first FR, and T_{guard,FR1} is a maximum T_{effect} among all positioning frequency layers in the first FR, T_{effect} being a period of Y measurement for each positioning frequency layer; T_{guard,FR2} is second time corresponding to the second FR, and T_{guard,FR2} is a maximum T_{effect} among all positioning frequency layers in the second FR.

12. The terminal device according to claim 10, wherein T_{Y,FR1} and T_{Y,FR2} are determined according to formulas as follows:
$${T}_{Y , FR 1} = {\sum }_{i = 1}^{L\_FR 1} {T}_{Y , i , F R 1} + ( L\_FR1 - 1 ) * max ( {T}_{effect , i} ) ; and$$
$${T}_{Y , FR 2} = {\sum }_{i = 1}^{L\_FR 2} {T}_{Y , i , FR 2} + ( L\_FR2 - 1 ) * max ( {T}_{effect , i} ) ;$$
wherein
i is an index of a positioning frequency layer; L_FR1 is a total number of positioning frequency layers of the first FR; L_FR2 is a total number of positioning frequency layers of the second FR; and T_{effect},i is a period of Y measurement in a positioning frequency layer i.

13. The terminal device according to claim 1, wherein the processor is configured to call and run the computer program stored in the memory, to cause the terminal device to perform:
determining the total positioning measurement time according to third positioning measurement time corresponding to a PRS processing window (PPW) and a maximum value among one or more periods of first positioning measurement time corresponding to one or more FRs.

14. The terminal device according to claim 13, wherein the processor is configured to call and run the computer program stored in the memory, to cause the terminal device to perform:
determining the total positioning measurement time according to the third positioning measurement time, first time, and the maximum value among the one or more periods of first positioning measurement time corresponding to the one or more FR MGs; or
determining the total positioning measurement time according to a sum of the third positioning measurement time and the maximum value among the one or more periods of first positioning measurement time corresponding to the one or more FR MGs; or
determining the total positioning measurement time according to a sum of the third positioning measurement time, first time and the maximum value among the one or more periods of first positioning measurement time corresponding to the one or more FR MGs.

15. The terminal device according to claim 1, wherein
first positioning measurement time corresponding to each FR is determined according to measurement time of measuring Y in each FR MG and/or measurement time of measuring Y in each FR PPW; or
the first positioning measurement time corresponding to each FR is determined according to the measurement time of measuring Y in each FR MG and/or the measurement time of measuring Y in each FR PPW, and according to first time or second time corresponding to each FR; wherein
Y comprises at least one of: PRS RSTD, RSRP for PRS, reference signal received path power (RSRPP) for PRS, or Rx-Tx time difference.

16. The terminal device according to claim 1, wherein
first positioning measurement time corresponding to each FR is determined according to a sum of measurement time of measuring Y in each FR MG and measurement time of measuring Y in each FR PPW; or
the first positioning measurement time corresponding to each FR is determined according to a sum of the measurement time of measuring Y in each FR MG, the measurement time of measuring Y in each FR PPW, and first time or second time corresponding to each FR; wherein
Y comprises at least one of: PRS RSTD, RSRP for PRS, reference signal received path power (RSRPP) for PRS, or Rx-Tx time difference.

17. A network device, comprising a processor and a memory, wherein the memory is configured to store a computer program; and
the processor is configured to call and run the computer program stored in the memory, to cause the network device to perform:
configuring one or more first frequency range (FR) gaps to a terminal device for positioning reference signal (PRS) measurement, wherein the one or more first FR gaps are are used for PRS measurement and for the terminal device to determine total positioning measurement time according to a maximum value among one or more periods of first positioning measurement time, the one or more periods of first positioning measurement time corresponding to one or more FRs.

18. The network device according to claim 17, wherein the processor is configured to call and run the computer program stored in the memory, to cause the network device to perform:
configuring the one or more first FR gaps to the terminal device for PRS measurement in a case where the network device receives support for an independent gap configuration PRS capability transmitted by the terminal device, or in a case where the network device receives support for a simultaneous processing of PRS for different FRs capability transmitted by the terminal device, or in a case where the network device receives the support for the independent gap configuration PRS capability and the support for the simultaneous processing of PRS for different FRs capability transmitted by the terminal device.

19. The network device according to claim 17, wherein the network device further performs:
configuring first information to the terminal device in a case where the network device receives support for an independent gap configuration PRS capability transmitted by the terminal device, or in a case where the network device receives support for the independent gap configuration PRS capability and a first capability transmitted by the terminal device; or
configuring second information to the terminal device in a case where the network device receives support for the independent gap configuration PRS capability and a second capability transmitted by the terminal device, or in a case where the network device receives support for the independent gap configuration PRS capability, the first capability and the second capability transmitted by the terminal device; wherein
the first capability indicates that the terminal device allows or supports configuring a first gap pattern as a per FR type, or the first capability indicates that the terminal device allows or supports the first gap pattern as per FR configuring a per FR type; the first gap pattern indicates a first measurement gap length (MGL) and a first measurement gap repetition period (MGRP);
the second capability indicates that the terminal device allows or supports configuring the one or more first FR gaps in multiple concurrent gaps as the first gap pattern;
the first information indicates to configure the first gap pattern as the per FR type, or the first information indicates the first gap pattern as per FR configuring the per FR type; and
the second information indicates to configure the one or more first FR gaps in the multiple concurrent gaps as the first gap pattern.

20. The network device according to claim 19, wherein the first gap pattern comprises measurement gap (MG) pattern 24 and/or MG pattern 25.
